(19) United States
(12) Patent Application Publication
(10) Pub. No.: US 2025/0390541 A1
(43) Pub. Date: Dec. 25, 2025

(54) INFORMATION PROCESSING METHOD AND RELATED DEVICE

(71) Applicant: Tencent Technology (Shenzhen) Company Limited, Shenzhen (CN)

(72) Inventors: Chuangmu YAO, Shenzhen (CN); Zhiyuan Lin, Shenzhen (CN); Zhiping Wang, Shenzhen (CN)

(21) Appl. No.: 19/255,901

(22) Filed: Jun. 30, 2025

Related U.S. Application Data
(63) Continuation of application No. PCT/CN2024/098947, filed on Jun. 13, 2024.

(30) Foreign Application Priority Data
Aug. 23, 2023 (CN) 202311070020.1

(51) Int. Cl. G06F 16/9535; G06F 16/9538

(52) U.S. Cl. CPC G06F 16/9535; G06F 16/9538

(57) ABSTRACT

Embodiments of this application provide an information processing method performed by a computer device. The method includes: displaying an information retrieval interface; displaying a subscription field in the information retrieval interface, the subscription field being a configured search field by a user of the computer device; obtaining the subscription field from the user of the computer device, the subscription field supporting editing, and the editing comprising modification or deletion; refreshing and displaying the changed subscription field when the subscription field changes due to editing; and outputting information related to the subscription field and subscribed by the user of the computer device. The embodiments of this application can enrich information retrieval manners, improve information retrieval flexibility, and better adapt to a scenario in which an object continuously follows information.

### CROSS-REFERENCE TO RELATED APPLICATIONS

This application is a continuation application of PCT Patent Application No. PCT/CN2024/098947, entitled “INFORMATION PROCESSING METHOD AND RELATED DEVICE” filed on Jun. 13, 2024, which claims priority to Chinese Patent Application No. 202311070020.1, entitled “INFORMATION PROCESSING METHOD AND RELATED DEVICE” filed with the China National Intellectual Property Administration on Aug. 23, 2023, both of which are incorporated by reference in their entirety.

### FIELD OF THE TECHNOLOGY

This application relates to the field of Internet technologies, and in particular, to an information processing method and a related device, especially an information processing method, an information processing apparatus, a computer device, a computer-readable storage medium, and a computer program product.

### BACKGROUND OF THE DISCLOSURE

Currently, an object (such as a user) may enter a search field (query) by using an information retrieval interface provided by a client, to retrieve information related to the search field. In addition, a search history of the object may be recorded on the information retrieval interface. When the object enters the information retrieval interface again, a recent (for example, recent several days) historical search field may be presented. The object taps the historical search field, and re-retrieval of the historical search field is initiated to obtain a service recall result. It is found through practice that existing information retrieval is excessively simple, is not flexible enough, and cannot adapt to a scenario in which the object continuously follows information.

### SUMMARY

Embodiments of this application provide an information processing method and a related device, to enrich information retrieval manners, improve information retrieval flexibility, and better adapt to a scenario in which an object continuously follows information.

According to an aspect, an embodiment of this application provides an information processing method performed by a computer device, and the method includes:
displaying an information retrieval interface;
displaying a subscription field in the information retrieval interface, the subscription field being a configured search field by a user of the computer device;
obtaining the subscription field from the user of the computer device, the subscription field supporting editing, and the editing comprising modification or deletion;
refreshing and displaying the changed subscription field when the subscription field changes due to editing; and
outputting information related to the subscription field and subscribed by the user of the computer device.

According to an aspect, an embodiment of this application provides a computer device, and the computer device includes:
a processor, configured to execute a computer program; and
a computer-readable storage medium, the computer-readable storage medium having the computer program stored therein, the computer program, when executed by the processor, causing the computer device to implement the foregoing information processing method.

According to an aspect, an embodiment of this application provides a non-transitory computer-readable storage medium, the computer-readable storage medium having a computer program stored therein, and the computer program, when loaded and executed by a processor of a computer device, causing the computer device to perform the foregoing information processing method.

In the embodiments of this application, the information retrieval interface is displayed, and the information retrieval interface is configured for performing information retrieval based on a search field. It can be learned that information retrieval may be performed based on the search field by displaying the information retrieval interface. A subscription field is displayed, and the subscription field is a configured search field. It can be learned that the object may configure the search field as the subscription field according to a continuous following requirement of the object. The configured search field that needs to be continuously followed may be presented by displaying the subscription field, to learn of a search field in which the object is continuously interested. The followed information related to the subscription field is outputted. In this way, information retrieval may be continuously performed by using the subscription field, to obtain and output information in which the object is continuously interested, thereby enriching information retrieval manners, improving information retrieval flexibility, and therefore, being capable of better adapting to a scenario in which the object continuously follows information.

### BRIEF DESCRIPTION OF THE DRAWINGS

FIG. 1 is an architectural diagram of an information processing system according to an exemplary embodiment of this application.

FIG. 2A is a schematic diagram of an information processing procedure according to an exemplary embodiment of this application.

FIG. 2B is a schematic flowchart of a subscription update notification according to an exemplary embodiment of this application.

FIG. 3A is a schematic flowchart of an information processing method according to an exemplary embodiment of this application.

FIG. 3B is a schematic diagram of outputting followed information related to a subscription field according to an exemplary embodiment of this application.

FIG. 4A is a schematic diagram of displaying N subscription fields according to an exemplary embodiment of this application.

FIG. 4B is a schematic diagram of displaying N subscription fields according to another exemplary embodiment of this application.

FIG. 4C is a schematic diagram of displaying N subscription fields according to still another exemplary embodiment of this application.

FIG. 4D is a schematic diagram of displaying N subscription fields in a collapsed manner according to an exemplary embodiment of this application.

FIG. 5A is a schematic diagram of outputting, in a fixed area, a plurality of documents matching a subscription field according to an exemplary embodiment of this application.

FIG. 5B is a schematic diagram of outputting a content update notification in a floating area according to an exemplary embodiment of this application.

FIG. 6A is a schematic diagram of setting a subscription field according to an exemplary embodiment of this application.

FIG. 6B is a schematic diagram of setting a subscription field according to another exemplary embodiment of this application.

FIG. 6C is a schematic diagram of setting a subscription field according to still another exemplary embodiment of this application.

FIG. 6D is a schematic diagram of setting a subscription field according to yet another exemplary embodiment of this application.

FIG. 6E is a schematic diagram of setting a subscription field according to an exemplary embodiment of this application.

FIG. 7A is a schematic diagram of deleting a subscription field word according to an exemplary embodiment of this application.

FIG. 7B is a schematic diagram of displaying a plurality of documents matching a subscription according to an exemplary embodiment of this application.

FIG. 7C is a schematic diagram of displaying a plurality of documents in sequence according to an exemplary embodiment of this application.

FIG. 7D is a schematic diagram of displaying a plurality of documents in clusters according to an exemplary embodiment of this application.

FIG. 7E is a schematic diagram of displaying a browsed document and a not browsed document in different areas of an information retrieval interface according to an exemplary embodiment of this application.

FIG. 7F is a schematic diagram of displaying a browsed document and a not browsed document according to an exemplary embodiment of this application.

FIG. 8A is a schematic diagram of a content update notification according to an exemplary embodiment of this application.

FIG. 8B is a schematic diagram of a content update notification according to another exemplary embodiment of this application.

FIG. 9 is a schematic diagram of a structure of an information processing apparatus according to an exemplary embodiment of this application.

FIG. 10 is a schematic diagram of a structure of a computer device according to an exemplary embodiment of this application.

### DESCRIPTION OF EMBODIMENTS

Related technical terms in embodiments of this application are first described as follows.

### 1. Search Field and Subscription Field

The search field (query) is a character string used for information retrieval. The search field may include a keyword. For example, the search field may include a character name, delicious food, a game name, or the like. Alternatively, the search field may include a sentence. For example, the search field may include “What are the delicious foods in XX city”. This is not limited in the embodiments of this application.

The subscription field is a configured search field that needs to be followed continuously (that is, needs to be followed in a particular time). Configuring the subscription field may be understood as performing following processing on a search field that needs to be followed continuously. That is, the search field is configured as the subscription field, so that followed information related to the subscription field may be triggered to be continuously followed, thereby providing an information retrieval service that can be continuously or periodically updated for an object.

### 2. Followed Information

The followed information refers to some information related to the subscription field. The followed information may be understood as information that is obtained by performing continuous (real-time or regular) information retrieval by using the subscription field and in which the object is continuously interested. The followed information includes, but is not limited to: a service recall result obtained by performing information retrieval based on the subscription field, a content update notification related to the subscription field, and the like. The service recall result is a result of recalling or extracting some documents for a particular service requirement (for example, an information retrieval requirement for a subscription field) by taking measures (for example, performing information retrieval). The service recall result may include a plurality of documents matching the subscription field. The matching herein means: a high matching degree between content of the document and the subscription field (for example, higher than a preset threshold). The plurality of documents may include a retrieved document and/or a recommended document. The retrieved document refers to a document that is retrieved through a search recall pipeline and that matches the subscription field. The recommended document refers to a document that is retrieved through a recommendation recall pipeline and that corresponds to a topic or a tag mapped to the subscription field. In the embodiments of this application, a function of the search recall pipeline is mainly to directly perform information retrieval based on a subscription field. A function of the recommendation recall pipeline is mainly to first perform mapping matching on a subscription field, to obtain a topic or a tag mapped to the subscription field, and then perform information retrieval based on the mapped topic or tag. The content update notification related to the subscription field is configured for prompting that there is an update to information related to the subscription field (that is, the followed information). The content update notification may include at least one of the following: a quantity of updated documents and a recommended reason. The quantity of updated documents refers to a quantity of documents with updates. For example, when the quantity of updated documents is 3, there are three documents with updates. The recommended reason may include: a document content type of the updated document. Exemplarily, it is assumed that the subscription field includes “model”, the document content type of the updated document may be a model technical principle, model introduction, and the like, and the recommended reason may be: “there is an update on a document that describes a model technical principle”; or the recommended reason may be: “there is an update on a document that describes a new model and related introductions”.

### 3. Topic and Tag of a Document

The document may include an article, a video, audio, an image, a web page, and the like. This is not limited in this application. The topic of the document is configured for describing main content of the entire document, for example, the topic of the document may be a title of an article, a name of a video, or the like. The tag of the document is configured for describing key information of the document, and the key information may include a type, a person, time, a place, and the like. The type herein may be, for example, a game, delicious food, or a model. Exemplarily, an example in which the document is a video is used, and for the video “Have you ever eaten such XX-type delicious food in XX place”, a topic of the video may be “Have you ever eaten such XX-type delicious food in XX place”, and a tag of the video may be, for example, XX place or XX-type delicious food. For another example, for an article “Xiaoming is good at playing XX games”, a topic of the article may be “Xiaoming is good at playing XX-type games”, and a tag of the article may include: Xiaoming and XX-type games.

In this application, for related data in an information processing process, for example, a behavior log of an object (such as a historical search field, a document browsing history, and an account followed by an object), and attribute information of an object (such as a nickname and a region), when the embodiments of this application are applied to a specific product or technology, the object's permission or consent needs to be obtained, and collection, use, and processing of the relevant data need to comply with relevant laws, regulations, and standards, conform to the principles of legality, legitimacy, and necessity, and do not involve the acquisition of data types prohibited or restricted by laws and regulations. In some exemplary embodiments, related data in the embodiments of this application is obtained after being separately authorized by the object. In addition, when the separate authorization of the object is obtained, a purpose of the related data is indicated to the object.

An embodiment of this application provides an information processing solution, and a general principle of the information processing solution is as follows: displaying an information retrieval interface, the information retrieval interface being configured for performing information retrieval based on a search field; displaying a subscription field, the subscription field being a configured search field; and outputting followed information related to the subscription field. In the foregoing manner, not only information retrieval may be performed on the information retrieval interface based on the search field, but also the object may configure the search field as the subscription field according to a continuous following requirement of the object. The configured search field that needs to be continuously followed may be presented by displaying the subscription field, to learn of a search field in which the object is continuously interested. Information retrieval may also be continuously performed by using the subscription field, to obtain and output information in which the object is continuously interested, thereby enriching information retrieval manners, improving information retrieval flexibility, and being capable of better adapting to a scenario in which the object continuously follows information.

An information processing system provided in the embodiments of this application is described below.

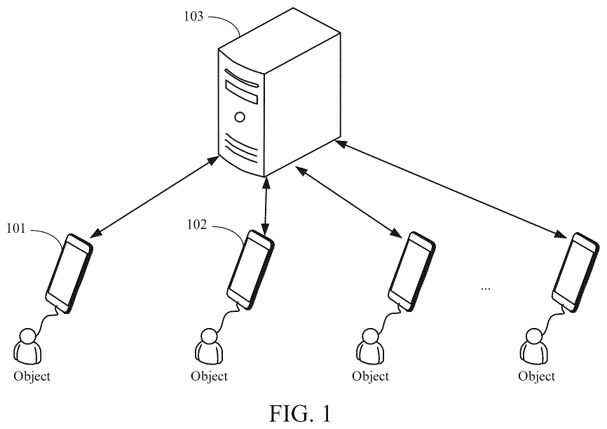

FIG. 1 is an architectural diagram of an information processing system according to an exemplary embodiment of this application. The information processing system includes a terminal 101, a terminal 102, . . . , and more terminals. A quantity of the terminals is not limited in this application. The information processing system further includes a server 103. Certainly, there may be a plurality of servers. This is still not limited in this application. The terminal may be understood as a terminal used by the object browsing the document. Any terminal in the information processing system and the server 103 are directly or indirectly connected in a wired or wireless communication manner, and any two terminals can exchange information through the server 103. Any terminal 101 is used as an example for description below.

The terminal 101 may provide an information retrieval interface. Any object using the terminal 101 may enter a search field on the information retrieval interface for information retrieval, and information matching the search field may be output through the information retrieval interface. The matched information may be a retrieval result obtained by performing information retrieval by using the search field. In addition, in this embodiment of this application, the object may further configure a subscription field on the information retrieval interface. The subscription field refers to a configured search field that needs to be followed continuously. Then, the terminal 101 may output followed information related to the subscription field. The terminal 101 may be a smartphone, a tablet computer, a notebook computer, a desktop computer, a smart in-vehicle terminal, a smart wearable device, and the like. This is not limited in the embodiments of this application.

The server 103 is configured to provide an information processing service for the terminal 101. The information processing service herein may include, but is not limited to: information retrieval performed based on the search field, a subscription field customization service provided for the object, information retrieval performed based on the subscription field, and other services. The server 103 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

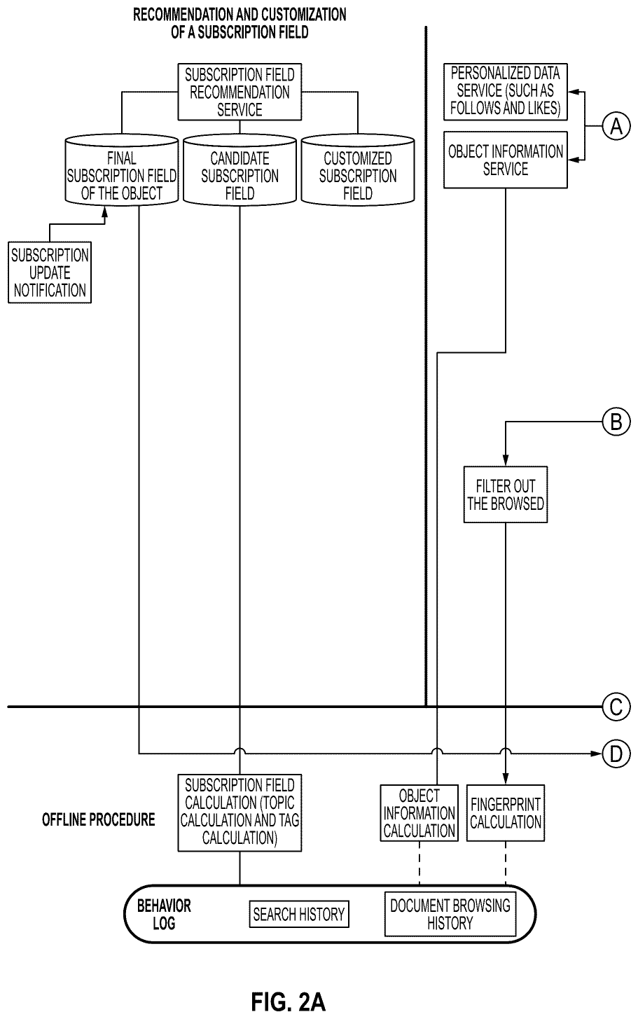

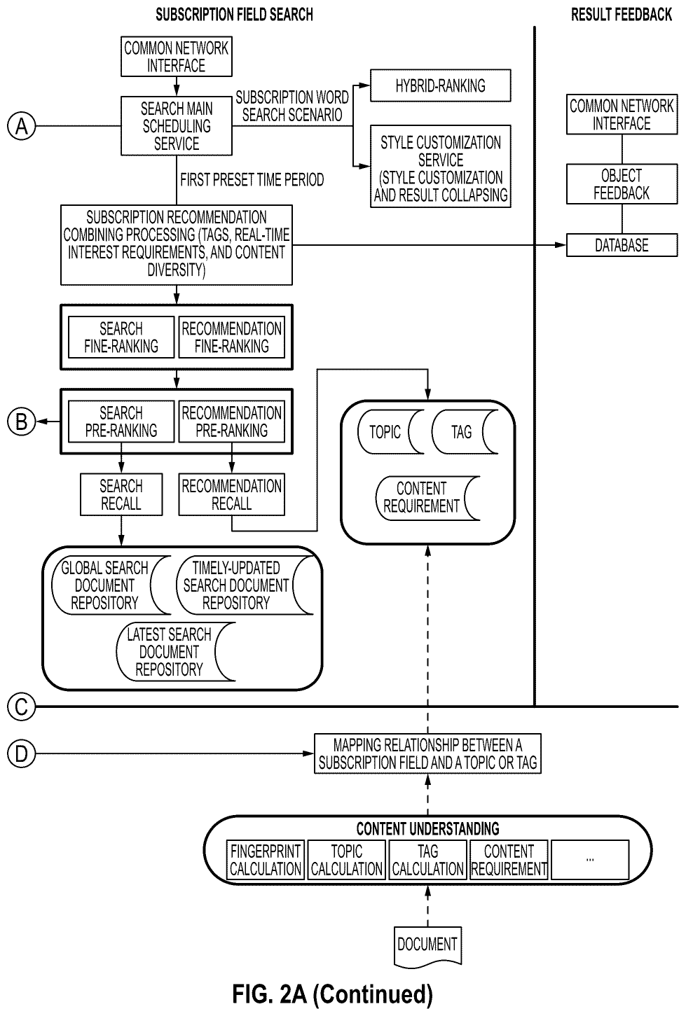

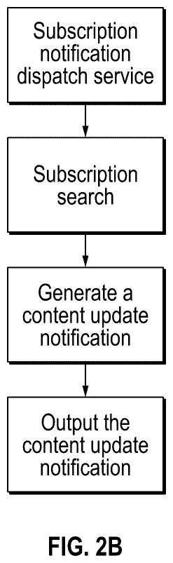

FIG. 2A is a schematic diagram of an information processing procedure according to an embodiment of this application. The information processing procedure may be performed by the server 103, and the information processing procedure includes: (1) Offline behavior log and document content understanding. This part includes recommendation calculation of a candidate search field, object information calculation, and document content understanding. (2) Recommendation and customization of a subscription field. (3) Subscription field search (that is, information retrieval based on a subscription field). (4) Result feedback of subscription search. (5) Content update notification. Next, the foregoing operations are described in detail.

### (1) Offline Behavior Log and Document Content Understanding

### 1.1 Recommendation Calculation of a Candidate Search Field

\textcircled{1} In an offline state, a behavior log of an object is collected based on a time cycle. Herein, the time cycle may be flexibly set. For example, the time cycle may be set based on a day level. For example, the time cycle may be one day or two days. For another example, the time cycle may be set based on an hour level. For example, the time cycle may be one hour or two hours. For still another example, the time cycle may be set based on a week level. For example, the time cycle may be one week or two weeks. The offline state refers to a state in which the terminal used by the object is disconnected from the Internet or a network. The behavior log of the object includes, but is not limited to: an information retrieval history (for example, the object inputs a historical search field in a historical time period for information retrieval), a video playback history (for example, a historical playback video of the object), a followed account (for example, an account that is followed by the object and that publishes an article or a video), likes (for example, the object likes an article, a video, or a video account), shares and forwards of the object (for example, the object shares and forwards an article or a video), and the like. After the behavior log of the object is obtained, candidate search field calculation may be performed on the behavior log by using a content tag clustering technology, to obtain one or more candidate search fields. The content tag clustering technology is a technology commonly used in the field of information retrieval, and is configured for clustering documents having similar topics or content together, to better organize and present content of a large quantity of documents. In an implementation, processing logic of using the content tag clustering technology includes: performing word segmentation processing on content (such as a historical search field or a title of a historical browsed document) in the behavior log of the object, to obtain one or more segmented words; vectorizing the one or more segmented words, to obtain a vector of each segmented word; and performing clustering calculation on the vector of each segmented word, to obtain a tag corresponding to each segmented word, and using the tag corresponding to each segmented word as the candidate search field.
\textcircled{2} After the candidate search field is obtained, the candidate search field may be bound with the object, and is stored in a database. Binding the candidate search field and the object means associating the candidate search field with an object identifier of the object (for example, being associated and stored in the database). Exemplarily, the database may include a key-value database (KV database for short). In this case, the object identifier of the object may be used as a key, and the candidate search field is used as a value, and are stored in the database. The object identifier herein may be a nickname, an account, or the like.

In this embodiment of this application, behavior logs of objects may be collected, candidate search fields respectively corresponding to the objects are determined in the foregoing manner, and the objects are bound to the corresponding candidate search fields. Therefore, when a subscription field is configured for an object, the server may directly recommend a corresponding candidate search field to the object for selection by the object, so that not only configuration efficiency of the subscription field can be improved, but also a subscription service of the search field can be provided for each object in a personalized manner.

### 1.2 Object Information Calculation

\textcircled{1} As described in 1.1, perform content tag clustering processing on collected behavior logs of the object by using the content tag clustering technology, to obtain one or more tags. Then, the one or more tags may be used as the object information. The object information is information configured for delineating an image and a characteristic of an object, is a typical object role virtually (abstractly) obtained from a real behavior of the object, and may be configured for describing a common feature of a type of object. The common feature may include, for example, a basic attribute (such as a region), interests, and hobbies. Exemplarily, if the time cycle is set based on a day level, that is, the behavior log of the object is collected based on a day level (for example, one day), content tag clustering processing is performed on the collected behavior log of the object by using the content tag clustering technology, to obtain one or more tags, and the one or more tags may be determined as object information of the object at the day level.
\textcircled{2} Collect the behavior log of the object in a plurality of time cycles (for example, a plurality of times at the day level), and generate object information in the plurality of time cycles according to \textcircled{1}. For example, when the time cycle is one day, content tag clustering processing is performed on behavior logs of the object collected on a plurality of days (for example, 100 days), to obtain object information on the plurality of days (for example, 100 days). Object information and object attribute information in a plurality of time cycles are combined, to obtain long-term object information of the object. The long-term object information is object information that does not change in a period of time (for example, one year or two years). The object attribute information may include, but is not limited to: gender, region, nickname, and the like.
\textcircled{3} Obtain object information and a behavior log of the object in a target time period, and perform content tag clustering processing on the object information and the behavior log in the target time period, to obtain a real-time interest requirement of the object. The real-time interest requirement indicates a followed direction of the object in a target time period. The target time period may be the latest three days, the latest three hours, or the like. This is not limited in this embodiment of this application. The “latest” herein uses a system time in which the object information and the behavior log of the object in the target time period are obtained as a reference, that is, the latest three days refer to three days before the system time, and the latest three hours refer to three hours before the system time. Exemplarily, object information and a behavior log of the object in latest three days are obtained. The behavior log, for example, records entertainment news that the object reads in the three days. Content tag clustering processing is performed on the object information and the behavior log of the object within the three days, to obtain the real-time interest requirement of the object. The real-time interest requirement indicates that the object pays more attention to entertainment information recently.

Both the long-term object information and the real-time interest requirement may be applied to a process of information retrieval based on a subscription field, and used as a basis for screening and ranking retrieved information (for example, retrieved documents).

### 1.3 Document Content Understanding

This part includes: establishing a correspondence between a browsed document and an object (that is, generating a historical browsing record of an object), and building a search document repository and a recall recommendation document repository.

### (1.3.1) Generate a Historical Browsing Record of an Object.

The behavior log of the object may include a document browsing history. The document browsing history refers to a record of documents that the object has browsed. For example, the document browsing history records which documents the object has browsed at what time, and these documents that have been browsed may be referred to as browsed documents. That is, the document browsing history includes the browsed document. In this embodiment of this application, fingerprint calculation may be performed on the browsed document, to obtain a fingerprint feature corresponding to the browsed document. Fingerprint calculation is a technology configured for determining uniqueness of document content. By performing fingerprint calculation on a document, a unique identifier (fingerprint feature) may be generated to represent content of the document. That is, the fingerprint feature of the document is configured for uniquely identifying a document, and a corresponding browsed document may be found by using a fingerprint feature of the browsed document. In an implementation, a process in which fingerprint calculation is performed on the browsed document, to obtain the fingerprint feature corresponding to the browsed document may include: extracting a plurality of content features of the browsed document (the content features herein may include, but are not limited to: a keyword of the document, a sentence in the document, and the like), performing hash calculation on the plurality of mentioned content features by using a hash algorithm, to obtain hash values corresponding to the content features, and combining the hash values corresponding to the content features, to obtain the fingerprint feature of the browsed document. For all subsequent involved fingerprint calculation, refer to the fingerprint calculation process of the browsed document.

After the fingerprint feature corresponding to the browsed document is obtained, in an implementation, the browsed document and the corresponding fingerprint feature may be used together as a historical browsing record of the object, and a browsed document filter is built based on the historical browsing record. Exemplarily, the browsed document filter may be a Bloom filter that uses a length of a browsed document list as a size. In another implementation, the browsed document and the corresponding fingerprint feature may be written into a database together as the historical browsing record of the object. Exemplarily, if the database is a KV database, the object identifier of the object may be used as a key, and the browsed document and the corresponding fingerprint feature may be used as a value, to be written into the database. Detailed description is provided below by using two examples:
Example 1: It is assumed that the browsed document includes a browsed article, and the browsed document filter includes a browsed article filter. A process of generating the historical browsing record of the object based on the browsed article may include: performing fingerprint calculation on a main body of the browsed article, and building the browsed article filter based on a fingerprint feature corresponding to the browsed article (for example, the browsed article filter may be a Bloom filter that uses a length of a browsed article list as a size). Alternatively, it is assumed that the database includes a KV database of the browsed article. A process of generating the historical browsing record of the object based on the browsed article may include: building the KV database of the browsed article by using the object identifier of the object as a key, and the fingerprint feature of the browsed article as a value.
Example 2: It is assumed that the browsed document includes a browsed video, and the browsed document filter includes a browsed video filter. A process of generating the historical browsing record of the object based on the browsed video may include: Frame extraction may be performed on a browsed video at a preset rate (the preset rate may be set according to a requirement, for example, one frame is extracted every 2s), fingerprint calculation is performed on an extracted video frame, to obtain a fingerprint feature corresponding to the video frame, and a browsed video filter is built based on the fingerprint feature corresponding to the video frame (exemplarily, the browsed video filter may be a Bloom filter that uses a length of a browsed video list as a size). Alternatively, it is assumed that the database includes a KV database of the browsed video. A process of generating the historical browsing record of the object based on the browsed video may include: building the KV database of the browsed video by using the object identifier of the object as a key, and the fingerprint feature of the browsed video as a value.

The generated historical browsing record of the object may be applied to a process of performing information retrieval based on the subscription field, and used as a basis for performing filtering processing on a document matching the subscription field. In this way, the object is prevented from receiving the browsed document again, redundant recommendation is avoided, and pressure of information interaction between the server and the terminal is reduced.

### (1.3.2) Build a Search Document Repository.

In an implementation, a full quantity of documents in the search document repository may be directly obtained. The full quantity of documents refer to all documents in the search document repository. Fingerprint calculation is performed on each obtained document, to obtain a fingerprint feature of each document. Each obtained document is used as a candidate retrieved document, and the fingerprint feature of each document is written into the search document repository as a document feature of the corresponding candidate retrieved document. Herein, the search document repository refers to a database that provides data support for information retrieval. That is, in this embodiment of this application, information retrieval is performed in the search document repository. Various types of documents may be recorded in the search document repository, which include, but are not limited to, a preset document, a received document uploaded by an object, a document obtained from the Internet, and the like. In addition, the search document repository supports continuous update.

In another implementation, the search document repository may be divided into a full search document repository (gob) and a local search document repository based on a document publication time, that is, the search document repository includes the full search document repository (gob) and the local search document repository. The document publication time refers to a time point at which a document is officially released or published. The full search document repository includes the full quantity of documents in the search document repository and a fingerprint feature of each document. In this case, a building manner of the full search document repository includes: obtaining the full quantity of documents in the search document repository, performing fingerprint calculation on each obtained document, to obtain a fingerprint feature of each document, using each obtained document as the candidate retrieved document, and using the fingerprint feature of each document as a document feature of the corresponding candidate retrieved document; and building the full search document repository based on the candidate retrieved document and the document feature of the candidate retrieved document.

The local search document repository is configured to store a local document. The local document is a concept relative to the full quantity of documents, that is, the local document refers to a part of the full quantity of documents. In this embodiment, the local document refers to a document in the search document repository with a document publication time being in a second preset time period, and the second preset time period may be a time period corresponding to the week level, the hour level, and the day level. Exemplarily, the local document may be a document published in a week, or a document published in two weeks. A building manner of the local search document repository includes: obtaining a document with a document publication time being in a second preset time period, performing fingerprint calculation on each document in the second preset time period, to obtain a fingerprint feature of each document in the second preset time period, using each document in the second preset time period as the local retrieved document, and using the fingerprint feature of each document in the second preset time period as a document feature corresponding to the local retrieved document; and building the local search document repository based on the local retrieved document and the document feature of the local retrieved document.

The local search document repository includes one or more of the following: a timely-updated search document repository (fob) and a latest search document repository (latest ob). In this embodiment of this application, various local search document repositories (that is, the timely-updated search document repository (fob) and the latest search document repository (latest ob)) may be built based on respective time cycles. Exemplarily, the timely-updated search document repository may be built by using the week level as the time cycle. For example, the timely-updated search document repository may include a document published in the latest week or a document published in the latest two weeks. The latest search document repository may be built by using the day level as the time cycle or using an hour as the time cycle. For example, the latest search document repository includes a document published in the latest day or includes a document published in the latest hour. Each type of ob is built based on a time cycle, to subsequently obtain, from a corresponding ob based on different requirements, a retrieved document matching the subscription field, thereby improving information retrieval efficiency. When the timely-updated search document repository (fob) is built by using the week level (for example, one week) as the time cycle, a document published in the latest week may be obtained, fingerprint calculation is performed on the obtained document, a fingerprint feature obtained through calculation is used as a document feature of the obtained document, and the obtained document and the corresponding document feature are written into the timely-updated search document repository (fob). When the latest search document repository (latest ob) is built by using the day level (for example, one day) as the time cycle, a document published in the latest day may be obtained, fingerprint calculation is performed on the obtained document, a fingerprint feature obtained through calculation is used as a document feature of the obtained document, and the obtained document and the corresponding document feature are written into the latest search document repository (latest ob).

(1.3.3) Build a recall recommendation document repository: Obtain documents in the latest period of time (for example, the latest month), to obtain P candidate recommended documents, P being a positive integer; score the P candidate recommended documents in an offline manner based on a recommendation impact factor, to obtain a score corresponding to each of the P candidate recommended documents; and perform ranking processing on the P candidate recommended documents in descending order of scores corresponding to the candidate recommended documents, to obtain the P ranked candidate recommended documents, obtain first Y candidate recommended documents from the P ranked candidate recommended documents, and build the recall recommendation document repository based on the first Y candidate recommended documents. Herein, the recall recommendation document repository refers to a database providing data support for the object in information recommendation. That is, in this embodiment of this application, information retrieval and recommendation are performed in the recall recommendation document repository based on the subscription field. The recall recommendation document repository may record various high-quality documents. The document may include, but is not limited to, a preset document, a received document uploaded by an object, a document obtained from the Internet, and the like. In addition, the recall recommendation document repository supports continuous update. The high-quality document generally refers to a document with high quality (quality of a main body is higher than a preset quality threshold), complete, clear, accurate, and reliable (that is, a content source is reliable, has a clear basis or data support, and trustworthy).

The recommendation impact factor may include at least one of the following: document originality, document activeness, a quantity of times of liking a document, a quantity of times of sharing a document, a quantity of times of forwarding a document, main body quality of a document, a document publication time, and the like. Some high-quality documents may be recorded in the recall recommendation document repository by using the recommendation impact factor.
\textcircled{1} Document originality: refers to an original document that is independently created and without reference from other documents. In this embodiment of this application, the scoring the P candidate recommended documents in an offline manner based on a recommendation impact factor, to obtain a score corresponding to each of the P candidate recommended documents may include: scoring the inputted P candidate recommended documents for document originality by using an originality determining model, to obtain a document originality score of each of the P candidate recommended documents, and using the document originality score of each candidate recommended document as a score of each candidate recommended document. The originality determining model refers to a model or a system configured to evaluate whether a work or a document has originality. The originality determining model usually determines, by using a natural language processing technology and a machine learning algorithm, a degree of originality of a document by comparing a similarity between the document and an existing work and by using a possible plagiarism behavior. Exemplarily, the originality determining model may include, but is not limited to: a model based on a TF-DF (word frequency and inverse document frequency), a model based on an N-gram (word segment), a model based on word embedding, a model based on a convolutional neural network, and the like. This is not limited in this application. \textcircled{2} Document activeness: may refer to a frequency at which a document is browsed. A higher browsing frequency of a candidate recommended document indicates higher activeness of the candidate recommended document, and the higher activeness of the candidate recommended document indicates a higher score of the candidate recommended document. \textcircled{3} Quantity of times of liking a document: refers to a quantity of times for which a document is liked. Like is a social interaction behavior, and means a manner of approving, supporting, or loving content of the document. A higher quantity of times for which the candidate recommended document is liked indicates a higher score of the candidate recommended document. \textcircled{4} Quantity of times of sharing a document: refers to a quantity of times for which a document is shared. Share is a process in which content, information, knowledge, or resources are spread to other people through various channels, so that more people may view, learn of, or benefit from the content, the information, the knowledge, or the resources. A higher quantity of times for which the candidate recommended document is shared indicates a higher score of the candidate recommended document. \textcircled{5} Quantity of times of forwarding a document: refers to a quantity of times for which a document is forwarded. Forward refers to a process in which a document is forwarded to other people, to expand a reach range of document content, so that more people may view and learn of the document content. A higher quantity of times for which the candidate recommended document is forwarded indicates a higher score of the candidate recommended document. \textcircled{6} Main body quality of a document: refers to quality and accuracy of main content of a document. The main body quality of the document may be evaluated from the perspectives of accuracy, completeness, logicality, structural clarity, and the like of the content. In this embodiment of this application, the P candidate recommended documents may be scored for document quality by using a document quality evaluation model, to obtain a score of each candidate recommended document. The document quality evaluation model refers to a model or a method for evaluating document quality. Exemplarily, the document quality evaluation model may include, but is not limited to: a machine learning model, a neural network model, a text classification model, and the like. \textcircled{7} Document publication time: refers to a time point at which a document is officially released or published. A later document publication time of the candidate recommended document indicates a higher score of the candidate recommended document, that is, a latest published candidate recommended document has a highest score, so that the object can obtain the latest recommended document when information retrieval is performed subsequently.

The foregoing recommendation impact factors may be flexibly selected to be used separately or in combination. For example, in the foregoing description, \textcircled{1} and \textcircled{2} are used in combination. For another example, the foregoing manners \textcircled{1} and \textcircled{3} may be used in combination, or \textcircled{1}, \textcircled{2}, and \textcircled{5} may be used in combination. Exemplarily, a proportion of each recommendation impact factor may be set. For example, the recommendation impact factors include document originality and main body quality of a document, a proportion of the document originality may be set to 30%, a proportion of the main body quality of the document may be set to 70%, and a weight may be set to comprehensively determine a score of a candidate recommended document. The candidate recommended documents are ranked by using a combination of a plurality of recommendation impact factors, so that a better candidate recommended document with higher quality may be selected as a recommended document to be recommended for the object.

In an implementation, the building the recall recommendation document repository based on the first Y candidate recommended documents may include: performing document topic calculation or content understanding on the first Y candidate recommended documents, to obtain a topic to which each candidate recommended document belongs; performing tag calculation or content understanding on the Y candidate recommended documents, to obtain a tag to which each candidate recommended document belongs; using the topic and/or the tag as the tag of each candidate recommended document; and building the recall recommendation document repository by using the topic and/or the tag as a retrieval keyword (key) and using a candidate recommended document (or a candidate recommended document list) that hits a corresponding topic and/or tag as index content. The recall recommendation document repository includes at least one of the following: candidate recommended documents corresponding to different topics, and candidate recommended documents corresponding to different tags. Exemplarily, a value of Y may be in the order of millions or tens of millions. For example, the value of Y may be one million or ten million.

(1.3.4) Further, to facilitate online recommendation recall, in this embodiment of this application, a mapping relationship between a subscription field and a topic may be further established, and a mapping relationship between a subscription field and a tag may be further established. When a recommended document is recalled, the subscription field may be used as a key to search for a mapped topic or tag, so that a corresponding candidate recommended document (or a candidate recommended document list) may be determined based on the topic or the tag mapped to the subscription field. The mapping relationship means that a topic or a tag mapped to the subscription field can be found by using the subscription field. A process of establishing the mapping relationship between a subscription field and a topic includes: determining a similarity between a subscription field and a topic, and establishing a mapping relationship between the subscription field and the topic when the similarity between the subscription field and the topic is greater than a preset similarity. In addition, a process of establishing the mapping relationship between a subscription field and a tag is as follows: determining a similarity between a subscription field and a tag, and establishing a mapping relationship between the subscription field and the tag when the similarity between the subscription field and the tag is greater than a preset similarity. Certainly, the mapping relationship between a subscription field and a topic and the mapping relationship between a subscription field and a tag may also be directly preset. For example, a mapping relationship between a subscription field “model” and a tag “Chat Generative Pre-trained Transformer (ChatGPT) model” is directly set.

### (2) Recommendation and Customization of a Subscription Field

In this embodiment of this application, a subscription field recommendation and customization module is added to the information retrieval interface. The subscription field recommendation and customization module supports configuring a subscription field, editing (for example, deleting or modifying) the configured subscription field, providing one or more candidate search fields for selection of the object, storing a subscription field configured by the object, and the like. A specific solution of the subscription field recommendation and customization module is as follows:

When the object configures a subscription field, this embodiment of this application may provide the following manner for configuring the subscription field: \textcircled{1} Because the object and a corresponding candidate search field are already stored in a database, the information retrieval interface includes a search subscription option, and the object may trigger the search subscription option. When the search subscription option is triggered, one or more candidate search fields corresponding to the object may be obtained from the foregoing database, and the one or more candidate search fields are displayed for selection of the object. After the object selects a candidate search field, the candidate search field may be configured as the subscription field. \textcircled{2} The object directly configures a user-defined subscription field. Specifically, the object may enter a search field in a search subscription input window, to configure the entered search field as the subscription field.

In addition, the subscription field supports editing, and the editing may include modification or deletion. Exemplarily, when the object is no longer interested in a subscription field, the object may delete the subscription field that is not of interest. In response to a deletion operation on the subscription field, the subscription field may be deleted. That the subscription field is deleted indicates that the corresponding search field is unsubscribed, and information related to the search field does not need to be continuously followed.

In an implementation, operation records such as selecting a candidate search field as a subscription field, configuring a user-defined subscription field, and deleting a subscription field may be recorded in a customized subscription field database (for example, a customized subscription field KV database) corresponding to the object. Specifically, the object identifier of the object is used as a key, and an operation record corresponding to the object is used as a value and stored in the customized subscription field database. In another implementation, the object and the subscription field configured by the object are stored in a target subscription field database (for example, the KV database). Specifically, the object identifier of the object is used as a key, and the subscription field configured by the object is used as a value and stored in the target subscription field database. Subsequently, related followed information may be outputted for the object based on the subscription field in the target subscription field database.

Any object may configure one or more subscription fields according to an interest of the object, to continuously obtain followed information related to the subscription fields.

### (3) Online Subscription Search Procedure

(3.1) Display a subscription field in a terminal used by the object. The object may trigger (for example, tap or double-tap) a subscription field to enter an information retrieval procedure. In response to a trigger operation on the subscription field, the server 103 may invoke a search background (Common Gateway Interface, CGI). Exemplarily, the search background CGI may be a web search CGI; and invoke a search main scheduling service program main mixer by using the search background CGI.
(3.2) The main scheduling service program main mixer invokes in parallel a Query understanding service program, an object information service program, and an object personalized data obtaining service program. The Query understanding service program is configured to perform query understanding on the subscription field to implement search recall. The performing query understanding on the subscription field herein includes: performing query word cutting on the subscription field, constructing a syntax tree based on a word cutting result, and performing intention identification on the subscription field, to obtain an intention identification result, thereby completing query understanding. The object information service program is configured to obtain object information, and the object information is configured for subsequently performing interest requirement matching and ranking on documents retrieved through information retrieval and for search recall of a personalized document. The object personalized data obtaining service program is configured to obtain personalized data, and the personalized data is configured for performing interest requirement matching and ranking on documents retrieved through information retrieval and for search recall of a personalized document.
(3.3) The main scheduling service program main mixer may initiate a recall invocation on a document based on the subscription field in a first preset time period (for example, the latest one month or two weeks), to obtain a service recall result. The recall invocation refers to performing information retrieval based on the subscription field, to obtain the service recall result. The service recall result may include a plurality of documents, and the plurality of documents include one or more of the following: a retrieved document and a recommended document. Correspondingly, in this embodiment of this application, when recall invocation is initiated for the two types of documents, two pipelines are involved. One is a search recall pipeline corresponding to the retrieved document, and the other is a recommended recall pipeline corresponding to the recommended document.
(3.4) The service recall result includes: a search recall result, and an obtaining manner of the search recall result may include the following operations S11 to S15.

S11: Search recall: Retrieve, from a search document repository through the search recall pipeline using the subscription field as query, M (M is a positive integer) candidate retrieved documents matching the subscription field in the first preset time period.

In an implementation, the search document repository includes a full search document repository, and M candidate retrieved documents whose document publication times are in the first preset time period and that match the subscription field are retrieved from the search document repository through the search recall pipeline. In another implementation, the search document repository includes a full search document repository, a timely-updated search document repository, and a latest search document repository. A to-be-used ob (that is, the full search document repository (gob), the timely-updated search document repository (fob), or the latest search document repository (latest ob)) may be determined based on the first preset time period, and the M candidate retrieved documents matching the subscription field are retrieved from the determined ob. For example, the first preset time period is the latest day, and the latest search document repository is built by using day-level as a time cycle. Therefore, it may be determined that the to-be-used ob is the latest search document repository (latest ob), and the M candidate retrieved documents matching the subscription field may be retrieved from the latest ob.

A specific implementation of the retrieving, from a search document repository, M candidate retrieved documents matching the subscription field in a first preset time period may be: performing fingerprint calculation on the subscription field, to obtain a fingerprint feature of the subscription field; and separately calculating a similarity between the fingerprint feature of the subscription field and a document feature of each of the candidate retrieved documents in the search document repository, and using a candidate retrieved document corresponding to a similarity greater than a similarity threshold as the candidate retrieved document matching the subscription field.

In an implementation, according to this embodiment of this application, research pre-ranking may be performed on the P candidate retrieved documents retrieved from the search document repository, to obtain the M candidate retrieved documents matching the subscription field, P being greater than or equal to M. The pre-ranking refers to a process in which a large quantity of documents (for example, P candidate retrieved documents) in the search document repository are initially screened and ranked, and some documents (for example, M candidate retrieved documents) having high degrees of relevance to the subscription field are extracted. Exemplarily, the retrieving, from a search document repository through the search recall pipeline, M candidate retrieved documents matching the subscription field in the first preset time period includes: retrieving, from the search document repository through the search recall pipeline, P candidate retrieved documents whose document publication times are in the first preset time period and that match the subscription field; and performing ranking processing on the P candidate retrieved documents in descending order of matching degrees with the subscription field, and determining, based on the P ranked candidate retrieved documents, the M candidate retrieved documents matching the subscription field. Specifically, first M candidate retrieved documents may be selected from the P ranked candidate retrieved documents as the M candidate retrieved documents matching the subscription field.

S12: Perform filtering processing on the M candidate retrieved documents based on a historical browsing record of an object, to obtain L candidate retrieved documents that are not browsed. In an implementation, a browsed document filter built based on the historical browsing record may be invoked to perform filtering processing on the M candidate retrieved documents, to obtain the L candidate retrieved documents that are not browsed. In another implementation, fingerprint calculation is performed on the M candidate retrieved documents, to obtain a fingerprint feature of each of the M candidate retrieved documents, the fingerprint feature is compared with a document feature of each of browsed documents in a browsed document database, and filtering processing is performed on candidate retrieved documents that match the fingerprint feature of the browsed document and that are in the M candidate retrieved documents, to obtain the L candidate retrieved documents that are not browsed. L is a positive integer, and L is less than or equal to M.

S13: Perform ranking processing on the L candidate retrieved documents that are not browsed, to obtain the L ranked candidate retrieved documents. The ranking herein may be understood as fine-ranking (that is, search fine-ranking) based on object information. The fine-ranking (that is, search fine-ranking) refers to a process of ranking search results according to a criterion (such as the object information). In an implementation, based on the object information, ranking processing is performed on the L candidate retrieved documents that are not browsed. If the object information indicates a high attention degree on delicious food (a higher attention degree indicates more interests of the object), a candidate document that is about delicious food and that is in the L candidate retrieved documents that are not browsed may be ranked high, and another candidate retrieved document in the L candidate retrieved documents that are not browsed is ranked low.

S14: Perform personalized retrieved document recall processing based on personalized data of the object, to obtain a personalized retrieved document. The personalized data includes, but is not limited to: a liked document, a shared document, a forwarded document, another object having an object relationship with the object, following a document of another object, and the like. The performing personalized retrieved document recall processing based on personalized data of the object, to obtain a personalized retrieved document may include: obtaining a document based on the personalized data, and determining the obtained document as the personalized retrieved document.

For example, the personalized data includes another object having an object relationship. The object relationship herein may include, but is not limited to: a friend relationship, a follow relationship, and the like in a social application. The performing personalized retrieved document recall processing based on personalized data of the object, to obtain a personalized retrieved document may include: obtaining a document browsed by another object, and using the obtained document as the personalized retrieved document. For another example, the personalized data includes a followed account, and the performing personalized retrieved document recall processing based on personalized data of the object, to obtain a personalized retrieved document may include: obtaining a document related to the followed account, and using the obtained document related to the followed account as the personalized retrieved document.

S15: Perform combining and ranking processing on the L ranked candidate retrieved documents and the personalized retrieved document, to obtain the search recall result. The search recall result may include one or more retrieved documents.

In an implementation, the combining and ranking processing includes at least one of the following: \textcircled{1} Perform deduplication processing on the L ranked candidate retrieved documents and the personalized retrieved document, to obtain deduplicated documents, and perform ranking processing on the deduplicated documents, to obtain the search recall result. \textcircled{2} Adjust an order of the L ranked candidate retrieved documents based on the personalized retrieved document, to obtain the search recall result. Exemplarily, the personalized retrieved document includes a document 1 and a document 2, the L candidate retrieved documents include a document 1 and a document 3, and an order of the document 1 in the L ranked candidate retrieved documents may be adjusted based on the document 1 in the personalized document (for example, the document 1 is adjusted to be ranked high in the L candidate retrieved documents), to obtain the search recall result.
(3.5) For the recommendation recall pipeline, the service recall result may further include: a recommendation recall result; and an obtaining manner of the service recall result may include the following operations S21 to S24.

S21: Recommendation recall: Determine, by using the subscription field as an index keyword (key) in the recall recommendation document repository provided by the recommendation recall pipeline, a topic or a tag mapped to the subscription field, and retrieve, based on the mapped topic or tag in the recall recommendation document repository provided by the recommendation recall pipeline, a candidate recommended document matching the subscription field, to recall a document from a plurality of recall directions such as the topic and the tag. Exemplarily, the subscription field is “model”, and the tag “ChatGPT model” mapped to the subscription field “model” is determined in the recall recommendation document repository provided by the recommendation recall pipeline. A candidate recommended document belonging to the tag “ChatGPT model” is retrieved based on the tag “ChatGPT model” in the recall recommendation document repository, and the retrieved candidate recommended document belonging to the tag “ChatGPT model” is determined as the candidate recommended document matching the subscription field.

S22: Perform recommendation pre-ranking on candidate recommended subscription information corresponding to the topic or the tag mapped to the subscription field. In an implementation, a ranking parameter may be obtained, and ranking processing is performed on the matched candidate recommended documents that are retrieved, to obtain the ranked candidate recommended documents. In this case, the ranking parameter includes: article quality, a matching degree with the subscription field, and the like. The matching degree with the subscription field is used as an example, and that ranking processing is performed on the matched candidate recommended documents that are retrieved, to obtain the ranked candidate recommended documents includes: performing, in descending order of matching degrees with the subscription field, ranking processing on the matched candidate recommended documents that are retrieved, to obtain the ranked candidate recommended documents. Exemplarily, it is assumed that there are three matched candidate recommended documents that are retrieved: a document 1, a document 2, and a document 3. When a matching degree between the document 1 and the subscription field is greater than a matching degree between the document 2 and the subscription field, and the matching degree between the document 2 and the subscription field is greater than a matching degree between the document 3 and the subscription field, the ranked candidate recommended documents are sequentially the document 1, the document 2, and the document 3.

S23: Perform filtering processing on the ranked candidate recommended documents based on the historical browsing record, to obtain not browsed candidate recommended documents. A specific implementation of operation S23 is similar to the specific implementation of operation S12, and details are not described herein again.

S24: Perform recommendation fine-ranking on the not browsed candidate recommended documents. In an implementation, the ranking processing is performed on the not browsed candidate recommended documents again based on the object information and the personalized data, to obtain a recommendation recall result. The not browsed candidate recommended documents on which the ranking processing is performed may be used as recommended documents, and the recommendation recall result may include one or more recommended documents. Specifically, weight calculation may be performed on the not browsed candidate recommended documents based on the object information and the personalized data, to obtain weights of the not browsed recommended documents. The ranking processing is performed on the not browsed candidate recommended documents again in descending order of the weights of the not browsed recommended documents, to obtain a recommendation recall result. In an implementation, that weight calculation may be performed on the not browsed candidate recommended documents based on the object information and the personalized data may be: determining, based on the object information and the personalized data, a not browsed candidate recommended document that the object follows, determining a weight of the followed not browsed candidate recommended document to be a large value, and setting weights of other not browsed candidate recommended documents to be small values.

The historical browsing record includes a browsed document. The document may be a video, an article, audio, or the like. Therefore, in this embodiment of this application, an example in which the document is an article or a video is used, and a search recall pipeline and a recommendation recall pipeline corresponding to the article may be added; and a search recall pipeline and a recommendation recall pipeline corresponding to the video are added to perform information retrieval from two directions: the video and the article, based on the subscription field, to obtain a service recall result. For the performing information retrieval from two directions: the video and the article, based on the subscription field, to obtain a service recall result, refer to the foregoing service recall result obtained by performing information retrieval based on the subscription field. This is not limited in this embodiment of this application.

In addition, in this embodiment of this application, browsed documents may be filtered according to operations S12 and S23. Certainly, in this embodiment of this application, the browsed document may alternatively not be filtered, but is directly recalled and collapsed during output. In this case, in the search recall pipeline, after the M candidate retrieved documents matching the subscription field in the first preset time period are retrieved from the search document repository through the search recall pipeline, ranking processing is directly performed on the M candidate retrieved documents to obtain the M ranked candidate retrieved documents; personalized retrieved document recall processing is performed based on personalized data of the object, to obtain a personalized retrieved document; and combining and ranking processing is performed on the M ranked candidate retrieved documents and the personalized retrieved document, to obtain the search recall result. In the recommendation recall pipeline, the ranking processing is performed on the ranked candidate recommended documents again based on the object information and the personalized data, to obtain the recommendation recall result. In addition, in this embodiment of this application, a document in which the object is not interested may be determined based on a behavior log of the object. For example, when the behavior log includes marking a document corresponding to a topic or a tag as being not of interest (for example, an attention degree is lower than an attention degree threshold), such a type of document may be filtered out. In this case, refer to the process of processing a browsed document, to process a document that is not of interest, and details are not described herein again.

In operations (3.4) and (3.5), processing such as filtering and collapsing is performed on the browsed document or the document that is not of interest, to actively display latest content related to the object information or an object interest requirement, satisfy a continuous interest consumption requirement of the object for the subscription field, and avoid, as much as possible, the object from repeatedly seeing a browsed document.

In this embodiment of this application, the recommendation recall pipeline and the search recall pipeline may be two independent pipelines. Certainly, the recommendation recall pipeline and the search recall pipeline belong to the same search pipeline. In this case, in the search recall pipeline, a topic or a tag of a document may be used as a text field of the document, and vectorization processing is performed on the text field of the document, to obtain a vector corresponding to the text field. Then, a search index may be built based on the vector corresponding to the text field of the document, to obtain a recall recommendation document repository. During information retrieval, document recall is directly performed in the recall recommendation document repository and the search document repository through the search recall pipeline. A document is recalled through a plurality of search recall manners.
(3.6) Subscription and recommendation combining processing: Perform, after obtaining a search recall result and a recommendation recall result, combining processing on the search recall result and the recommendation recall result, to obtain a service recall result, and return the service recall result to the main mixer. In an implementation, the performing combining processing on the search recall result and the recommendation recall result may include: directly determining the search recall result and the recommendation recall result as service recall results. In another implementation, the performing combining processing on the search recall result and the recommendation recall result may include: performing deduplication processing on a retrieved document in the search recall result and a recommended document in the recommendation recall result, to obtain the service recall results. In still another implementation, the performing combining processing on the search recall result and the recommendation recall result may include: performing combining and ranking on the retrieved document in the search recall result and the recommended document in the recommendation recall result according to a combining policy, to obtain the service recall result. The combining policy includes an attention degree combining display rule, a subscription field matching degree combining rule, and a document diversity combining display rule.

When the combining display rule includes the attention degree combining display rule, the performing combining and ranking on the retrieved document in the search recall result and the recommended document in the recommendation recall result according to a combining policy, to obtain the service recall result includes: performing combining and ranking on the retrieved document in the search recall result and the recommended document in the recommendation recall result in descending order of the attention degrees, to obtain the service recall result. For example, when an attention degree of the retrieved document in the search recall result is greater than an attention degree of the recommended document in the recommendation recall result, the retrieved document is ranked before the recommended document in the descending order of the attention degrees, to obtain the service recall result. The attention degree may be determined by a real-time interest requirement of the object. For example, if the real-time interest requirement indicates that an attention direction of the object is delicacy food, the retrieved document is a document about delicacy food, and the attention degree of the retrieved document is greater than the attention degree of the recommended document.

When the combining display rule includes the subscription field matching degree combining rule, the subscription field matching degree combining rule may include a matching degree with a topic of the subscription field or a matching degree with a tag of the subscription field. An example in which the subscription field matching degree combining rule includes the matching degree with the topic of the subscription field is used, and the performing combining and ranking on the retrieved document in the search recall result and the recommended document in the recommendation recall result according to a combining policy, to obtain the service recall result includes: determining a matching degree between the retrieved document and the topic of the subscription field, determining a matching degree between the recommended document and the topic of the subscription field, and performing combining and ranking on the retrieved document and the recommended document in descending order of matching degrees with the topic of the subscription field, to obtain the service recall result.

When the combining display rule includes the document diversity combining display rule, for example, the document diversity combining display rule includes a quantity of documents of the same account, the performing combining and ranking on the retrieved document in the search recall result and the recommended document in the recommendation recall result according to a combining policy, to obtain the service recall result includes: performing combining processing on the retrieved document in the search recall result and the recommended document in the recommendation recall result based on the quantity of documents of the same account, to obtain the service recall result. Exemplarily, there are four retrieved documents in the search recall result, three of the retrieved documents belong to the same account, there are two recommended documents in the recommendation recall result, and the two recommended documents belong to the same account. It is assumed that a quantity of documents of the same account is not more than two, and in this case, combining processing may be performed on the four retrieved documents and the two recommended documents based on a quantity of documents of the same account. The combining processing herein may include: deleting any one of the three retrieved documents belonging to the same account, and a finally obtained service recall result includes three retrieved documents and two recommended documents.

(3.7) The main mixer may directly output, after obtaining a service recall result, the service recall result. Alternatively, after obtaining a service recall result, the main mixer performs multi-service result hybrid-ranking on documents in the service recall result, to obtain a hybrid-ranked service recall result, and outputs the hybrid-ranked service recall result. In an implementation, multi-service result hybrid-ranking may be performed on the documents in the service recall result based on a real-time interest requirement and/or a document diversity requirement. Exemplarily, multi-service result hybrid-ranking is performed on the documents in the service recall result based on the document diversity requirement. For example, the documents in the service recall result include an article and a video; and the requirement on document diversity includes alternately ranking of the video and the article. Consequently, the article and the video in the service recall result may be alternately ranked based on the document diversity requirement, to obtain a hybrid-ranked service recall result.
(3.8) In some embodiments, if special style customization is set in subscription search, the main mixer invokes a style customization service program (mergesvr) to perform style customization on the hybrid-ranked service recall result, and feeds back the customized service recall result to the terminal, so that the terminal outputs the customized service recall result. The style customization may include, but is not limited to: a topic aggregation style, a tag aggregation style, and the like. Exemplarily, the style customization includes the topic aggregation style. Topic aggregation may be performed on the documents in the service recall result, and documents belonging to the same topic are displayed in an area.

### (4) Result Feedback of Subscription Search

After obtaining the service recall result, the object may invoke, in a process of browsing the service recall result, a feedback CGI (webquery CGI) to provide feedback on a browsed document. Exemplarily, a document that is not of interest or a document that is of interest is marked. In response to the marking operation, the feedback of the object is recorded into a database (KV database). In a subscription search process (3.6): Perform combining and ranking on the search recall result and the recommendation recall result, weights of the retrieved document in the search recall result and the recommended document in the recommendation recall result may be adjusted based on the feedback of the object, filtering is directly performed on the retrieved document in the search recall result and the recommended document in the recommendation recall result, or the like. When the feedback of the object indicates being not of interest in the document, the weight adjustment herein may be: when a similarity between the retrieved document and the marked document is high, a weight of the retrieved document or the recommended document may be reduced. When the feedback of the object indicates being of interest in the document, the weight adjustment herein may be: when the similarity between the retrieved document and the marked document is high, the weight of the retrieved document or the weight of the recommended document may be increased.

### (5) Content Update Notification

When there is an update to content (a document) related to the subscription field, a content update notification of the subscription field may be generated, and the content update notification is output. The content update notification may inform the object that there is a content update to the followed subscription field, to facilitate continuous consumption of the object (for example, facilitate browsing and querying of the object). FIG. 2B is a schematic flowchart of a subscription update notification according to an exemplary embodiment of this application. An entire process for the subscription update notification is as follows.
(5.1) Subscription notification dispatch service program: Scan a target subscription field database of an object by using a subscription notification dispatch service program of a server at a cycle of minute level, and perform scattered dispatch in time by using the object as a dimension, to be added to a dispatch queue, that is, different objects are evenly scattered in time to be added to a queue, to avoid a system pressure of updating calculation. The scattered dispatch refers to a dispatch policy that destroys an original dispatch order in a randomization manner or other manners, to improve system performance or fairness. Exemplarily, subscription fields corresponding to 100 objects may be added to a dispatch queue every one minute or two minutes.
(5.2) Subscription search: The server may obtain the subscription field of the object from the dispatch queue, and performs document recall again from the search recall pipeline and the recommendation recall pipeline. In an implementation, one or more local retrieved documents matching the subscription field are retrieved from a local search document repository through the search recall pipeline; and filtering processing is performed, based on the historical browsing record of the object, on the one or more local retrieved documents retrieved in the search recall pipeline, to obtain a first filtering result. Because the document is updated frequently, there may be a document that is updated and notified last time. In this case, based on a historical browsing record and a notified document, filtering processing is performed on the one or more local retrieved documents retrieved in the search recall pipeline, that is, the notified document is filtered out from the one or more local retrieved documents, to obtain a first filtering result.

A process of retrieving one or more local retrieved documents matching the subscription field from the local search document repository is similar to the process of retrieving the M candidate retrieved documents matching the subscription field from the search document repository, and details are not described herein again.
(5.3) Determine, from the recall recommendation document repository provided by the recommendation recall pipeline, a topic or a tag mapped to the subscription field, and retrieve, in the recall recommendation document repository based on the mapped topic or tag, one or more candidate recommended documents matching the subscription field; and perform, based on the historical browsing record, filtering processing on the one or more candidate recommended documents retrieved in the recommendation recall pipeline, to obtain a second filtering result. The performing filtering processing on the one or more candidate recommended documents retrieved in the recommendation recall pipeline herein is similar to that in (5.2), and details are not described again.
(5.4) Generate a content update notification: Perform combining processing on the first filtering result and the second filtering result, to obtain an update recall result; and generate a content update notification of the subscription field based on the update recall result if the update recall result is not an empty set. In an implementation, because the update is frequent, a content update notification may not be generated for a previously obtained update recall result. In this case, combining processing may be performed on the previous update recall result and a current update recall result, to obtain a content update notification. That is, the content update notification includes the update recall result for which no notification is updated in time and the current update recall result. In another implementation, the content update notification of the subscription field is directly generated based on the update recall result. The content update notification may include one or two of the following: a quantity of updated documents and a recommended reason. When the content update notification includes the recommended reason, content tag clustering processing may be performed on the document in the update recall result, to obtain a type of the document in the update recall result, and generate the recommended reason based on the type of the document. For example, if it is obtained, after the document in the update recall result is clustered, that the type to which the document in the update recall result belongs is a technical principle about a model, the recommended reason that there is a document update of the technical principle about the model may be output.
(5.5) The server invokes a push service program to output the content update notification of the subscription field. Exemplarily, the content update notification may be outputted in a highlighting manner (for example, an origin with a color).

The content update notification is actively outputted, so that the object does not need to actively check, on the information retrieval interface, whether there is a content update of a configured subscription field. This simplifies an information retrieval operation, improves information retrieval efficiency, and can better improve object experience.

An information processing method provided in the embodiments of this application is described below.

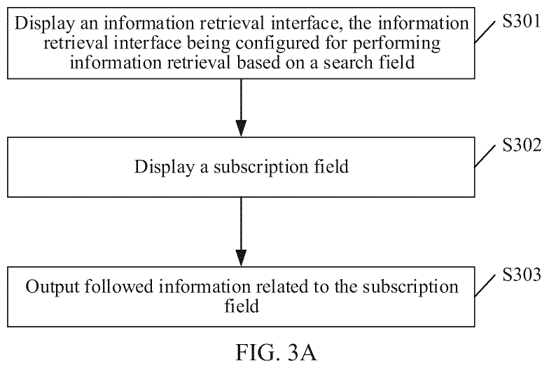

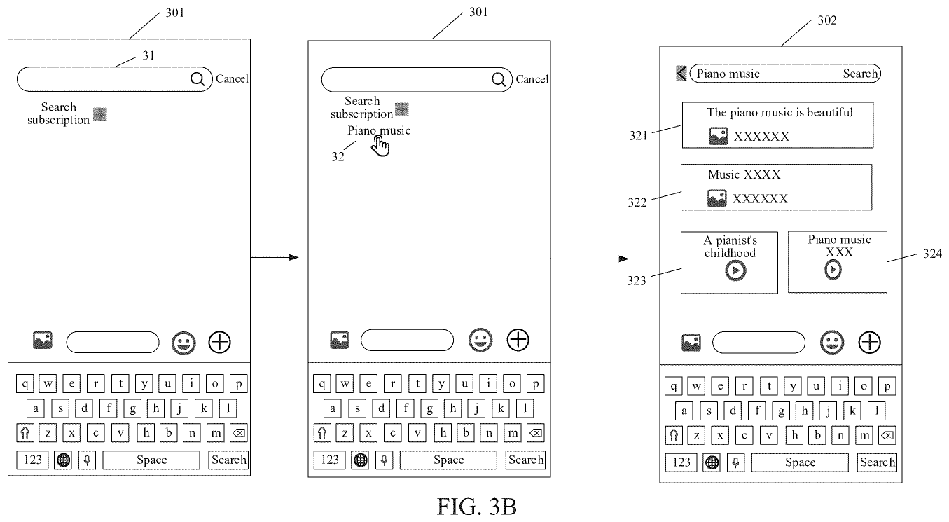

FIG. 3A is a schematic flowchart of an information processing method according to an exemplary embodiment of this application. The information processing method may be performed by the computer device in the foregoing information processing system, the computer device may be the terminal in the foregoing information processing system, and the information processing method may include the following operations S301 to S303.

S301: Display an information retrieval interface, the information retrieval interface being configured for performing information retrieval based on a search field.

The search field may include a keyword, a complete sentence, and the like. Exemplarily, the search field may be Xiaoming, music, delicious food, and the like. The search field may be “How long is a gourmet festival”. For example, FIG. 3B is a schematic diagram of outputting followed information related to subscription information according to an embodiment of this application. The information retrieval interface is shown in FIG. 3B. A search field input control 31 is provided on an information retrieval interface 301. An object may enter a search field in the search field input control 31, to implement information search based on the search field.

S302: Display a subscription field, the subscription field being a configured search field that needs to be followed continuously.

In an implementation, the object may configure a subscription field that is of interest on the information retrieval interface, and correspondingly, the terminal may obtain the configured subscription field, and display the subscription field. The displaying the subscription field may include at least one of the following: \textcircled{1} Display the subscription field on the information retrieval interface. As shown in FIG. 3B, the subscription field 32 is displayed on the information retrieval interface. A display location of the subscription field 32 may be flexibly set. For example, the subscription field 32 may be displayed at a fixed location on the information retrieval interface, or the subscription field 32 may be displayed on the information retrieval interface in a floating manner. This is not limited in this embodiment of this application. \textcircled{2} Display the subscription field on a first interface independent of the information retrieval interface. The first interface may be any interface other than the information retrieval interface. For example, the information retrieval interface is displayed on a client. The first interface may be a main interface, a service interface, a session message interface, or the like of the client independent of the information retrieval interface. A display location of the subscription field may be flexibly set. For example, the subscription field may be displayed at a fixed location on the first interface, or the subscription field may be displayed on the first interface in a floating manner. The display interface of the subscription field and the display location of the subscription field on the display interface are not limited in this embodiment of this application.

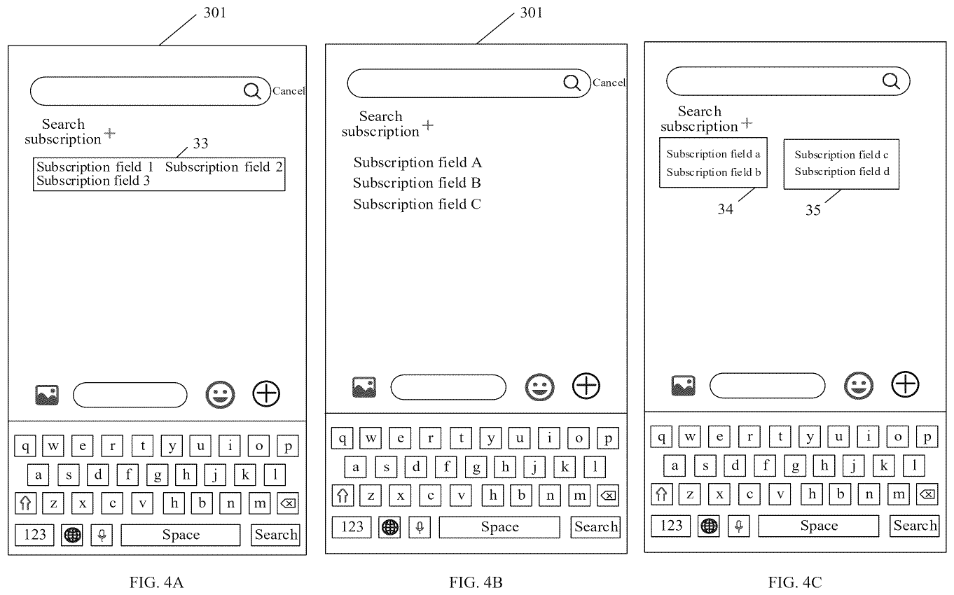

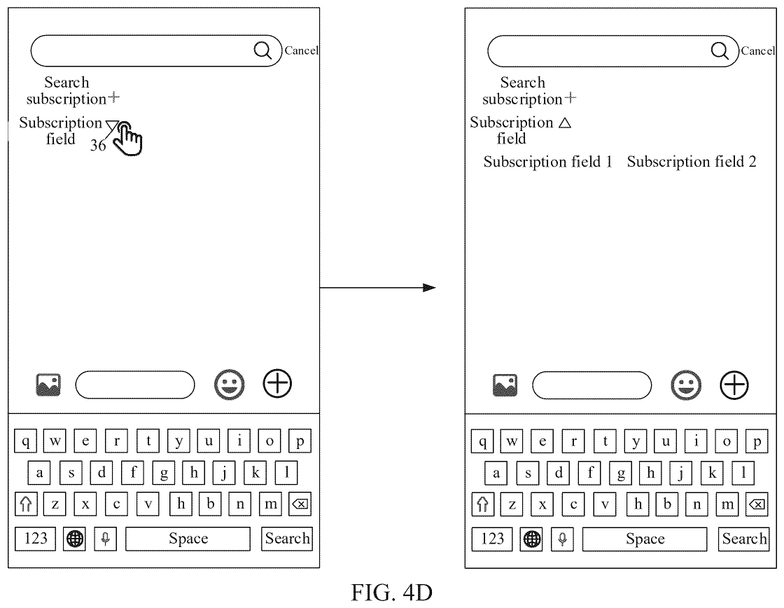

In this embodiment of this application, a quantity of subscription fields may be N, and Nis a positive integer. The displaying the subscription field may include at least one of the following: \textcircled{1} Display N subscription fields in a tiled manner. Exemplarily, FIG. 4A is a schematic diagram of displaying N subscription fields according to an exemplary embodiment of this application. In FIG. 4A, an example in which the subscription field is displayed on the information retrieval interface is used. A subscription field 1, a subscription field 2, and a subscription field 3 are displayed in a tiled manner in an area 33 of the information retrieval interface 301. \textcircled{2} Display the N subscription fields according to a time order in which the N subscription fields are configured. Exemplarily, N=3, a time at which a subscription field A is configured is earlier than a time at which a subscription field B is configured, and the time at which the subscription field B is configured is earlier than a time at which a subscription field C is configured. An example in which the subscription fields are displayed on the information retrieval interface is used, and the subscription field A, the subscription field B, and the subscription field C may be displayed on the information retrieval interface according to a time order in which the three subscription fields are configured. \textcircled{3} Display the N subscription fields in descending order of attention degrees. A higher attention degree of the subscription field indicates that the object is more interested in the subscription field. Exemplarily, an attention degree of the subscription field A is higher than an attention degree of the subscription field B, and the attention degree of the subscription field B is higher than an attention degree of the subscription field C. FIG. 4B is a schematic diagram of displaying N subscription fields according to another exemplary embodiment of this application. An example in which the subscription field is displayed on the information retrieval interface is used. As shown in FIG. 4B, N=3, and the subscription field A, the subscription field B, and the subscription field C are displayed in descending order of the attention degrees on the information retrieval interface. \textcircled{4} Randomly display the N subscription fields. \textcircled{5} Display the N subscription fields by category based on topics to which the N subscription fields respectively belong. In an implementation, an example in which the subscription field is displayed on the information retrieval interface is used, and the displaying the N subscription fields by category based on topics to which the N subscription fields respectively belong may include: displaying subscription fields belonging to different topics in different areas of the information retrieval interface, and displaying subscription fields belonging to the same topic in the same area. Exemplarily, an example in which the subscription field is displayed on the information retrieval interface is used. FIG. 4C is a schematic diagram of displaying N subscription fields according to still another exemplary embodiment of this application. In FIG. 4C, a subscription field a and a subscription field b belong to the same topic, a subscription field c and a subscription field d belong to the same topic. On an information retrieval interface 302, the subscription field a and the subscription field b are displayed in an area 34, and the subscription field c and the subscription field d are displayed in an area 35. \textcircled{6} Display the N subscription fields in a collapsed manner. An example in which the subscription field is displayed on the information retrieval interface is used. FIG. 4D is a schematic diagram of displaying N subscription fields in a collapsed manner according to an exemplary embodiment of this application. In FIG. 4D, two (N=2) subscription fields are displayed on the information retrieval interface in the collapsed manner, and the collapsed subscription fields support being triggered to be expanded and displayed. The information retrieval interface in FIG. 4D includes a subscription field expansion option 36. In response to a trigger operation on the subscription field expansion option 36, two collapsed subscription fields (that is, a subscription field 1 and a subscription field 2) are displayed. \textcircled{7} Display the N subscription fields in descending order of field lengths of the N subscription fields. Exemplarily, a field length of a subscription field “XX city” is 4, and a field length of a subscription field “XXXX delicious food” is 6. An example in which the subscription field is displayed on the information retrieval interface is used, and the subscription field “XXXX delicious food” and the subscription field “XX city” are displayed on the information retrieval interface in descending order of the field lengths of the two subscription fields.

S303: Output followed information related to the subscription field.

In an implementation, a quantity of subscription fields is N, and the outputting followed information related to the subscription field includes: in response to a selection operation on the subscription field, outputting followed information related to the subscription field selected in the selection operation. The followed information includes, but is not limited to: a service recall result obtained by performing information retrieval based on the subscription field, a content update notification, and the like. The service recall result may include a plurality of documents matching the subscription field. The plurality of documents may include a recommended document and/or a retrieved document. For example, in FIG. 3B, a document 321, a document 322, a document 323, and a document 324 related to the subscription field are outputted. The content update notification may be configured for prompting that there is an update to the document related to the subscription field, and the content update notification may include one or two of the following: a quantity of updated documents and a recommended reason.

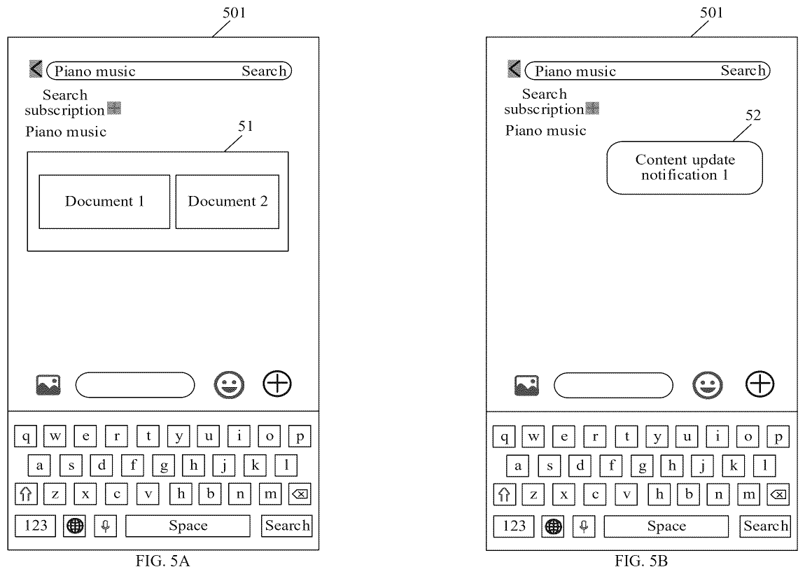

In this embodiment of this application, the outputting followed information related to the subscription field may include at least one of the following: \textcircled{1} Output the followed information in a fixed area on the information retrieval interface. The fixed area may be any area on the information retrieval interface, such as an upper area, a middle area, or a right area. This is not limited in this embodiment of this application. Exemplarily, an example in which the followed information includes a service recall result, and the service recall result includes a document 1 and a document 2 matching the subscription field is used. FIG. 5A is a schematic diagram of outputting, in a fixed area, a plurality of documents matching a subscription field according to an exemplary embodiment of this application. In FIG. 5A, the document 1 and the document 2 matching the subscription field are displayed in a fixed area 51 of an information retrieval interface 501. \textcircled{2} Output the followed information in a floating area on the information retrieval interface. Exemplarily, an example in which the followed information includes a content update notification is used. FIG. 5B is a schematic diagram of outputting a content update notification in a floating area according to an exemplary embodiment of this application. In FIG. 5B, a content update notification 1 related to the subscription field is displayed in a floating area 52 of the information retrieval interface 501. \textcircled{3} Output the followed information on a second interface independent of the information retrieval interface. Exemplarily, an example in which the followed information includes a service recall result, and the service recall result includes a document 1 and a document 2 matching the subscription field is used. As shown in FIG. 3B, a document 321, a document 322, a document 323, and a document 324 matching the subscription field are displayed on a second interface 302 independent of the information retrieval interface 301. The second interface may be any interface other than the information retrieval interface. For example, the information retrieval interface is displayed on a client. The second interface may be a main interface, a service interface, a session message interface, or the like of the client independent of the information retrieval interface. The second interface is not limited in this embodiment of this application.

In this embodiment of this application, the information retrieval interface is displayed, and the information retrieval interface is configured for performing information retrieval based on a search field; a subscription field is displayed, and the subscription field is a configured search field; and followed information related to the subscription field is outputted. In the foregoing manner, not only information retrieval may be performed on the information retrieval interface based on the search field, but also the object may configure the search field as the subscription field according to a continuous following requirement of the object. The configured search field that needs to be continuously followed may be presented by displaying the subscription field, to learn of a search field in which the object is continuously interested. Information retrieval may also be continuously performed by using the subscription field, to obtain and output information in which the object is continuously interested, thereby enriching information retrieval manners, improving information retrieval flexibility, and being capable of satisfying a requirement that the object continuously follows information.

A specific implementation process of obtaining a subscription field provided in the embodiments of this application is described below.

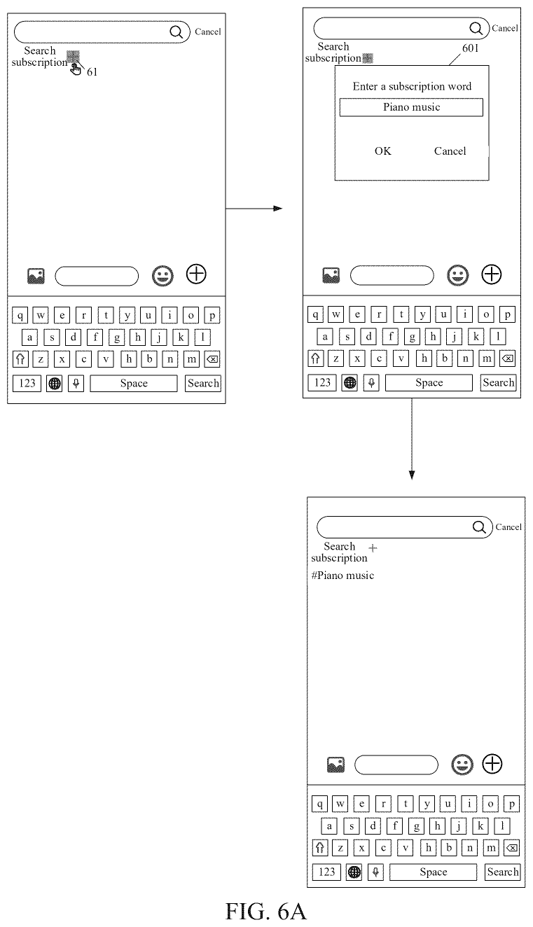

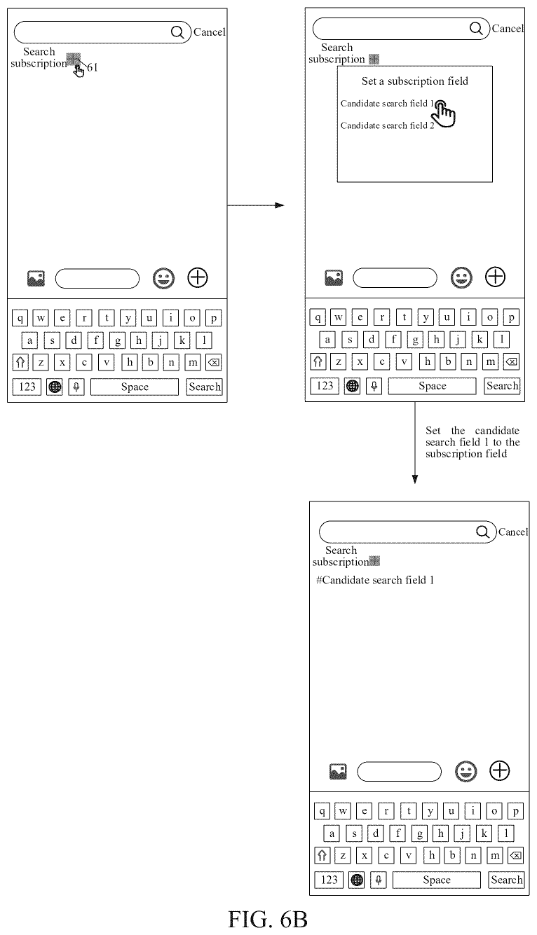

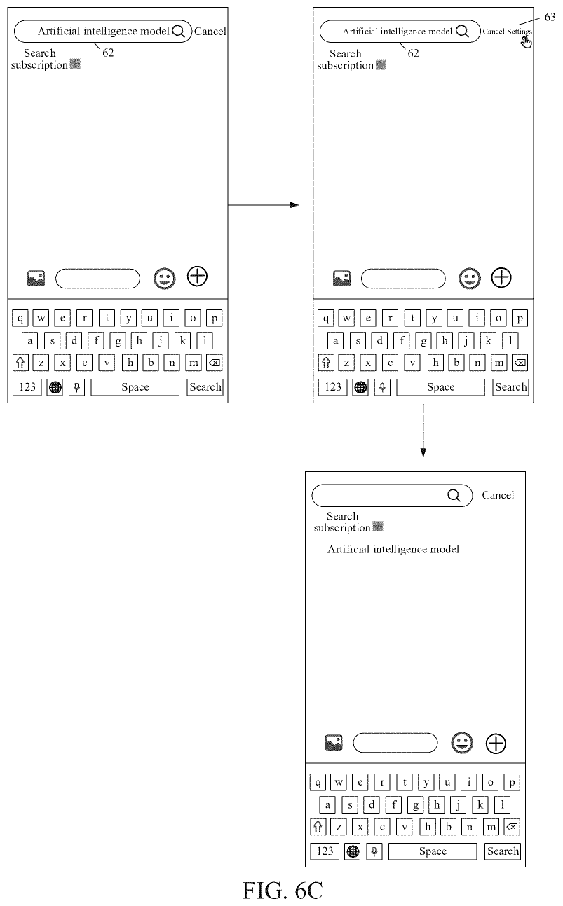

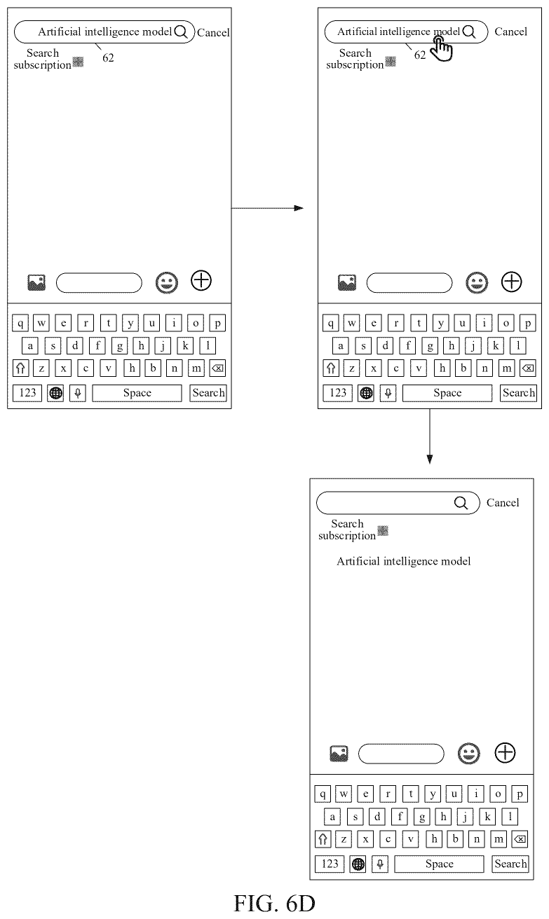

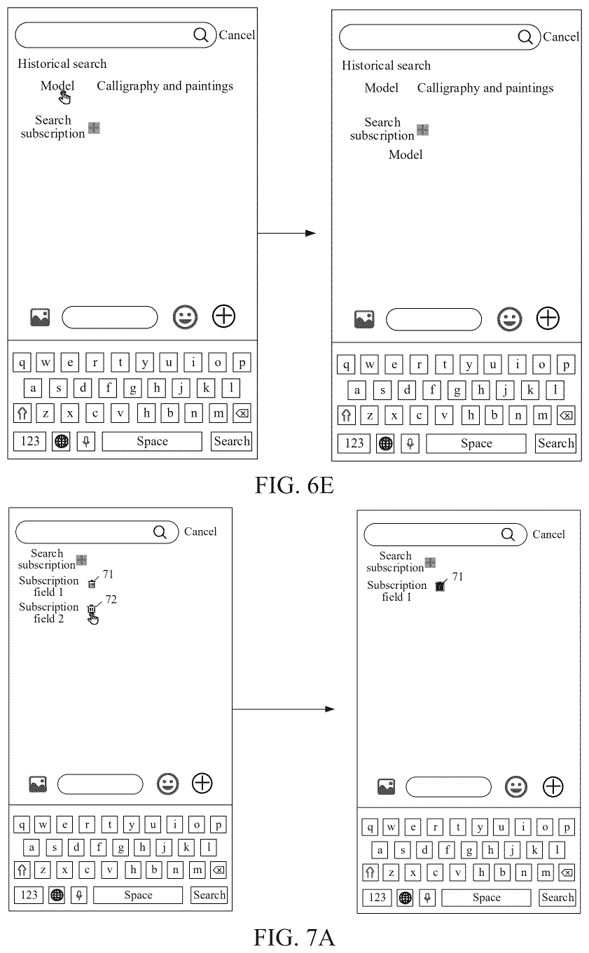

In an embodiment, the obtaining a subscription field may include, but is not limited to the following manners.
\textcircled{1} The information retrieval interface is provided with a search subscription option. An object may trigger the search subscription option to execute a configuration operation, and enter a subscription field in a search subscription input window. In this implementation, the obtaining a subscription field includes: displaying the search subscription input window in response to triggering of the search subscription option, receiving a first search field entered in the search subscription input window, and configuring the first search field as the subscription field. A triggering manner of the search subscription option may be: tapping, double-tapping, voice triggering, sliding, and the like. Exemplarily, FIG. 6A is a schematic diagram of configuring a subscription field according to an exemplary embodiment of this application. In FIG. 6A, an information retrieval interface is provided with a search subscription option 61. An object taps the search subscription option 61, a search subscription input window 601 is displayed in response to triggering of the search subscription option 61, and the object may enter a first search field “piano music” in the search subscription input window 601. Correspondingly, the first search field “piano music” inputted in the search subscription input window 601 is received, and the first search field “piano music” is configured as the subscription field.
\textcircled{2} The information retrieval interface is provided with a search subscription option. The obtaining a subscription field includes: displaying one or more candidate search fields in response to triggering of the search subscription option; and receiving a selection operation on the candidate search field, and configuring the selected candidate search field as the subscription field. The one or more candidate search fields may be directly displayed on the information retrieval interface, or the one or more candidate search fields may be displayed on the search subscription input window, or the one or more candidate search fields may be displayed on a search subscription interface independent of the information retrieval interface. This is not limited in this embodiment of this application.

Exemplarily, FIG. 6B is a schematic diagram of setting a subscription field according to another exemplary embodiment of this application. In FIG. 6B, an information retrieval interface is provided with a search subscription option 61. An object taps the search subscription option 61, two candidate search fields, a candidate search field 1 and a candidate search field 2, are displayed in response to triggering of the search subscription option 61, and the object may select one or two candidate search fields from the two candidate search fields to be configured as the subscription field. It is assumed that the object selects the candidate search field 1, a selection operation on the candidate search field 1 is received, and the selected candidate search field 1 is configured as the subscription field.

An obtaining manner of the one or more candidate search fields includes: obtaining, from a database based on an object identifier of the object, one or more candidate search fields corresponding to the object identifier. The candidate search field is obtained by collecting behavior logs of the object within a time cycle (such as a day level or an hour level) and performing candidate search subscription field calculation on the behavior logs by using a content tag clustering technology.

When the object triggers the search subscription option, one or more candidate search subscription fields may be displayed in the search subscription input window. In this case, the object may input, in the search subscription input window according to an interest requirement in a user-defined manner, the first search field that needs to be configured as the subscription field, or may directly select, from the one or more candidate search fields, the candidate search field that needs to be configured as the subscription field.
\textcircled{3} The information retrieval interface includes a search field input control. In this implementation, the obtaining a subscription field includes: receiving a second search field inputted in the search field input control, and configuring the second search field as the subscription field in response to a configuration operation on the second search field.

The configuration operation on the second search field may include any one of the following: A: A subscription setting option is displayed on the information retrieval interface, and the configuration operation on the second search field may include a trigger operation on the subscription setting option. The subscription setting option may be displayed on the information retrieval interface after the second search field inputted in the search field input control is received. Alternatively, the subscription setting option is always displayed on the information retrieval interface, to configure the second search field inputted in the search field input control as the subscription field. Exemplarily, FIG. 6C is a schematic diagram of setting a subscription field according to still another exemplary embodiment of this application. In FIG. 6C, an information retrieval interface includes a search field input control 62. An object may enter a second search field “artificial intelligence model” in the search field input control 62. Correspondingly, the second search field “artificial intelligence model” inputted in the search field input control is received, a subscription setting option 63 is displayed on the information retrieval interface, and the second search field “artificial intelligence model” is configured as the subscription field in response to a trigger operation of displaying the subscription setting option 63. B: Perform an operation such as tapping or double-tapping in a preset area of the information retrieval interface. The preset area may be a middle area, a left area, a right area, or the like on the information retrieval interface. This is not limited in this embodiment of this application. C: An operation such as double-tap, movement, or tap on the second search field. Exemplarily, FIG. 6D is a schematic diagram of setting a subscription field according to yet another exemplary embodiment of this application. In FIG. 6D, an information retrieval interface includes a search field input control 62. An object may enter a second search field “artificial intelligence model” in the search field input control 62. Correspondingly, the second search field “artificial intelligence model” inputted in the search field input control is received, the object taps the second search field “artificial intelligence model”, and the second search field “artificial intelligence model” is configured as the subscription field in response to a tap operation on the second search field. D: An input operation of a specific gesture on the information retrieval interface, and the specific gesture may include, but is not limited to: an M gesture, an OK gesture, and the like.
\textcircled{4} After performing information retrieval based on the search field, the object records a historical search field. Therefore, in this embodiment of this application, the obtaining a subscription field may include: displaying at least one historical search field, the historical search field being a search field used in a historical information retrieval process; and receiving a selection operation on the historical search field, and configuring the selected historical search field as the subscription field. Exemplarily, FIG. 6E is a schematic diagram of setting a subscription field according to an exemplary embodiment of this application. In FIG. 6E, two historical search fields: a historical search field “model” and a historical search field “calligraphy and paintings” are displayed on the information retrieval interface. The object may select one or both of the historical search field “model” and the historical search field “calligraphy and paintings” to be set as the subscription field. It is assumed that the object selects the historical search field “model”, and correspondingly, a selection operation on the historical search field “model” is received, and the historical search field “model” is used as the subscription field.

In this embodiment of this application, the subscription field supports editing, and the editing herein may include: modification or deletion. When the editing includes modification, in an implementation, a modification option of the subscription field is displayed, the object may trigger the modification option in a manner of tapping, double-tapping, or the like. In response to a trigger operation on the modification option, the subscription field may be set to an editable state, and when a modification operation on the subscription field is received, the subscription field is modified.

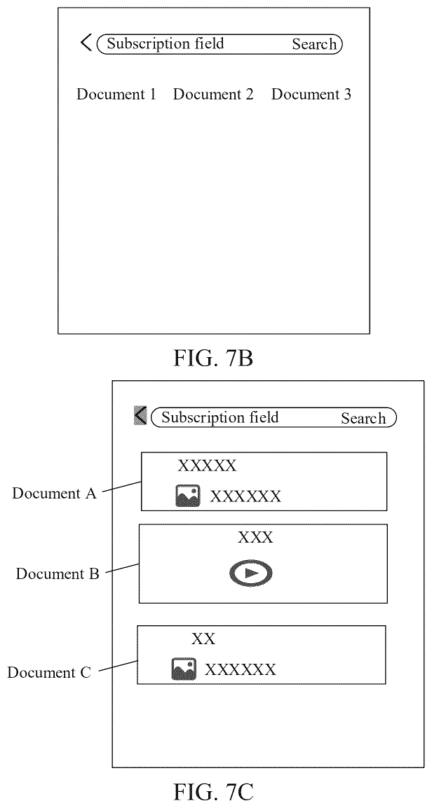

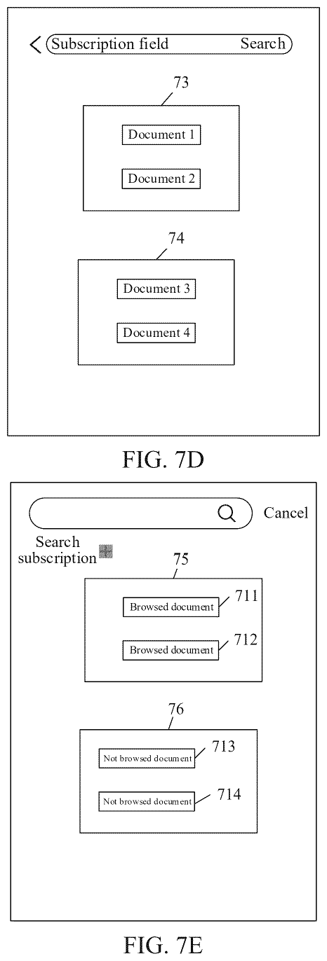

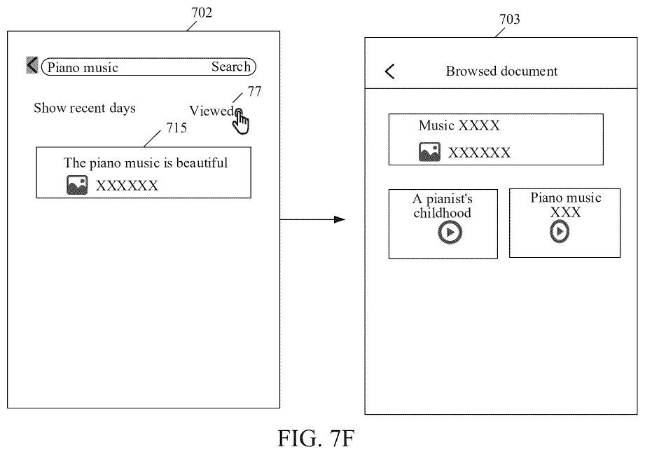

When the editing includes deletion, in an implementation, a deletion option of the subscription field may be displayed, the object may trigger the deletion option in a manner of tapping, double-tapping, or the like, and in response to a trigger operation on the deletion option, the subscription field is deleted. Exemplarily, FIG. 7A is a schematic diagram of deleting a subscription field word according to an exemplary embodiment of this application. In FIG. 7A, a subscription field 1 and a subscription field 2 are displayed on the information retrieval interface, and a deletion option 71 corresponding to the subscription field 1 and a deletion option 72 corresponding to the subscription field 2 are further displayed. When an object taps the deletion option 72 corresponding to the subscription field 2, the subscription field 2 is deleted from the information retrieval interface in response to a tap operation on the deletion option 72 corresponding to the subscription field 2. In another implementation, the object may move a subscription field that needs to be deleted to a fixed area, and in response to a moving operation on the subscription field, the moved subscription field may be deleted from the information retrieval interface.

In some feasible embodiments, when the subscription field changes due to editing, a changed subscription field needs to be refreshed and displayed. Exemplarily, in FIG. 7A, after the subscription field 2 is deleted, the changed subscription field is refreshed and displayed on the information retrieval interface, that is, only the field 1 is displayed on the information retrieval interface. A quantity of the changed subscription fields is M, Mis less than or equal to N, and the refreshing and displaying the changed subscription field may include at least one of the following: \textcircled{1} Display M changed subscription fields in a tiled manner; \textcircled{2} Display the M changed subscription fields according to a time order in which the M changed subscription fields are configured; \textcircled{3} Display the M changed subscription fields in descending order of attention degrees; \textcircled{4} Randomly display the M changed subscription fields; and \textcircled{5} Display the M changed subscription fields in descending order of field lengths of the M changed subscription fields.

An example in which the subscription field is displayed on the information retrieval interface is used above for description. When the subscription field changes due to editing, the changed subscription field may be refreshed and displayed on a second interface independent of the information retrieval interface.

As described above, in this embodiment of this application, a manner of setting the subscription field is very flexible. For example, when the subscription field is set, the object is supported in setting the subscription field in a user-defined manner and selecting a candidate search field to be configured as the subscription field. For another example, when the subscription field is set, it is supported to configure a first search field inputted in a search subscription input window as the subscription field. The subscription field is flexibly configured, to promote content consumption of the object in a scenario of a continuous interest requirement.

The outputting followed information related to the subscription field in this embodiment of this application is described below.

As described above, the followed information includes a service recall result obtained by performing information retrieval based on the subscription field, a content update notification, and the like. In a possible embodiment, the followed information includes the service recall result obtained by performing information retrieval based on the subscription field. The service recall result may include a plurality of documents matching the subscription field, and the documents include articles, web pages, videos, images, audio, and the like. In this embodiment, the outputting followed information related to the subscription field includes at least one of the following.
(1) Display the plurality of documents in a random order.
(2) Display the plurality of documents in descending order of matching degrees between each document and the subscription field. In an implementation, a matching degree between each document and the subscription field may be determined, and the plurality of documents are displayed in descending order of the matching degrees between each document and the subscription field. Exemplarily, FIG. 7B is a schematic diagram of displaying a plurality of documents matching a subscription according to an exemplary embodiment of this application. In FIG. 7B, the service recall result includes three documents. A matching degree between a document 1 and the subscription field is 98%, a matching degree between a document 2 and the subscription field is 88%, and a matching degree between a document 3 and the subscription field is 80%. The document 1, the document 2, and the document 3 are displayed in descending order of the matching degrees between each document and the subscription field.
(3) Display the plurality of documents in descending order of attention degrees. The attention degree may be understood as a degree of interest of the object. A higher degree of interest of the object indicates a higher attention degree. Exemplarily, the subscription field is “Chat Generative Pre-trained Transformer (ChatGPT) model”, and a plurality of documents matching the subscription field include: a document 1 “technical implementation of the ChatGPT model”, and a document 2 “brief description of an AI model”. When the object is interested in the ChatGPT model, an attention degree of the document 1 “technical implementation of the ChatGPT model” is higher than an attention degree of the document 2 “brief description of an AI model”, and the document 1 “technical implementation of the ChatGPT model” and the document 2 “brief description of an AI model” are displayed in descending order of the attention degrees.

The attention degree of the document may be determined according to a real- time interest requirement of the object. The real-time interest requirement may be obtained by performing content tag clustering processing based on behavior logs and object information of the object within the latest time cycle (for example, the latest three days or the latest week) to a system time. For example, if the real-time interest requirement indicates that the object is interested in the ChatGPT model, a high attention degree may be set for a document related to the ChatGPT model.
(4) Display the plurality of documents in sequence according to a requirement on document diversity. The document diversity may include, but is not limited to: diversity of document carriers, diversity of document sources, and the like. The document carrier may include a video, an article, a web page, audio, and the like, and the document source may include: an account to which a document belongs, a document publication platform, and the like. Exemplarily, the requirement on document diversity includes: a requirement on document carrier diversity, that is, a document carrier is required to include an article and a video alternately ranked. FIG. 7C is a schematic diagram of displaying a plurality of documents in sequence according to an exemplary embodiment of this application. In FIG. 7C, the plurality of documents include a document A, a document B, and a document C, a document carrier of the document A is a video, a document carrier of the document B is a video, and a document carrier of the document C is an article. The document A, the document C, and the document B are displayed in sequence according to the requirement on document carrier diversity. Exemplarily, the requirement on document diversity includes: a requirement on document account diversity, that is, it is required that no more than two documents belonging to the same account are displayed at a time. The plurality of documents include a document A, a document B, a document C, and a document D. The document A, the document B, and the document C all belong to an account A, and the document D belongs to an account B. The document A, the document B, the document D, and the document C are displayed in sequence according to the requirement on document account diversity.
(5) Display the plurality of documents in clusters based on topics or tags to which the documents belong. In an implementation, the displaying the plurality of documents in clusters based on topics to which the documents belong includes: displaying documents belonging to different topics in different areas by category, and displaying documents belonging to the same topic in the same area in clusters. Exemplarily, a document 1 and a document 2 belong to a topic 1, and a document 3 and a document 4 belong to a topic 2. FIG. 7D is a schematic diagram of displaying a plurality of documents in clusters according to an exemplary embodiment of this application. In FIG. 7D, the document 1 and the document 2 are displayed in an area 73 in clusters based on the topic to which the documents belong, and the document 3 and the document 4 are displayed in an area 74 in clusters based on the topic to which the documents belong. In another implementation, the displaying the plurality of documents in clusters based on tags to which the documents belong includes: displaying documents belonging to different tags in different areas by category, and displaying documents belonging to the same tag in the same area in clusters. Exemplarily, a tag to which the document 1 and the document 2 belong is beautiful scenery, a tag to which the document 3 and the document 4 belong is tree planting, the document 1 and the document 2 are displayed in a first area in clusters, and the document 3 and the document 4 are displayed in a second area in clusters.

In some feasible embodiments, the plurality of documents may include a browsed document and a not browsed document, and the outputting followed information related to the subscription field includes at least one of the following.
\textcircled{1} Filter out the browsed document, and displaying only the not browsed document. In an implementation, after a service recall result is obtained, browsed document filtering processing may be performed on the service recall result based on a historical browsing record, to obtain the not browsed document, and only the not browsed document is displayed on the interface. Specifically, the historical browsing record includes a fingerprint feature of the browsed document, and the performing browsed document filtering processing on the service recall result based on a historical browsing record, to obtain the not browsed document includes: determining fingerprint features of documents in the service recall result, comparing the fingerprint features of the documents in the service recall result with the fingerprint feature of the browsed document in the historical browsing record, and filtering out a document having the same fingerprint feature as the browsed document, to obtain the not browsed document.

In this embodiment of this application, the plurality of documents may include only not browsed documents. That is, when information retrieval is performed based on the subscription field, browsed document filtering processing may be performed on a document obtained through retrieval. Therefore, the obtained service recall result no longer includes a browsed document. In this case, the not browsed document is directly displayed.
\textcircled{2} Display the browsed document and the not browsed document in different areas of the same interface. Exemplarily, FIG. 7E is a schematic diagram of displaying a browsed document and a not browsed document in different areas of an information retrieval interface according to an exemplary embodiment of this application. In FIG. 7E, a browsed document 711 and a browsed document 712 are displayed in an area 75 of the information retrieval interface, and a not browsed document 713 and a not browsed document 714 are displayed in an area 76 of the information retrieval interface.
\textcircled{3} Display the browsed document and the not browsed document on different interfaces.
\textcircled{4} Display the not browsed document, and collapsing the browsed document on a display interface of the not browsed document, the collapsed browsed document supporting being triggered to be expanded and displayed. In an implementation, the collapsed browsed document corresponds to a display option, and when the display option is triggered, the browsed document may be displayed in an expanded manner on the display interface or a new interface independent of the display interface. Exemplarily, FIG. 7F is a schematic diagram of displaying a browsed document and a not browsed document according to an exemplary embodiment of this application. In FIG. 7F, the not browsed document includes a document 715. The document 715 is displayed on the display interface 702, and the browsed document is collapsed on the display interface 702. The collapsed browsed document corresponds to a display option 77, and when the display option 77 is triggered, the browsed document is displayed in an expanded manner on a new interface 703 independent of the display interface.
\textcircled{5} Display the plurality of documents, and highlighting the not browsed document in the plurality of documents. The highlighting the not browsed document in the plurality of documents may include at least one of the following: the not browsed document is displayed in a bold manner, the not browsed document is displayed in an inclined manner, or the like.

In some other feasible embodiments, the plurality of documents may include a retrieved document and a recommended document, and the outputting followed information related to the subscription field includes at least one of the following A to E: A: Hide the retrieved document, and displaying only the recommended document. B: Hide the recommended document, and displaying only the retrieved document. The hidden document supports being triggered to be expanded and displayed. C: Display the retrieved document and the recommended document by category. Exemplarily, the retrieved document may be displayed in a first display area of an interface, and the recommended document is displayed in a second area of the same interface. D: Display the retrieved document and the recommended document in a combined manner. In an implementation, the displaying the retrieved document and the recommended document in a combined manner may include: performing deduplication processing on the retrieved document and the recommended document, to obtain a deduplicated retrieved document and a deduplicated recommended document, and displaying the deduplicated retrieved document and the deduplicated recommended document. For example, the retrieved document includes a document 1 and a document 2, and the recommended document includes the document 1 and a document 3. The displaying the retrieved document and the recommended document in a combined manner may be performing deduplication processing on the document 1, the document 2, the document 1, and the document 3, to obtain the document 1, the document 2, and the document 3, and displaying the document 1, the document 2, and the document 3.

In another implementation, the retrieved document and the recommended document are displayed in a combined manner according to a combining display rule. The combining display rule includes one or more of the following: an attention degree combining display rule, a subscription field matching degree combining rule, and a document diversity combining display rule. When the combining display rule includes the attention degree combining display rule, the displaying the retrieved document and the recommended document in a combined manner according to a combining display rule includes: displaying the retrieved document and the recommended document in a combined manner in descending order of attention degrees. For example, an attention degree of the retrieved document is greater than an attention degree of the recommended document. The retrieved document and the recommended document are displayed in a combined manner in descending order of the attention degrees. That is, the retrieved document and the recommended document are displayed in descending order of the attention degrees.

When the combining display rule includes the subscription field matching degree combining rule, the subscription field matching degree combining rule may include a matching degree with a topic corresponding to the subscription field or a matching degree with a tag corresponding to the subscription field. The subscription field matching degree combining rule includes the matching degree with the topic corresponding to the subscription field, and the displaying the retrieved document and the recommended document in a combined manner according to a combining display rule includes: determining a matching degree between the retrieved document and the topic corresponding to the subscription field, determining a matching degree between the recommended document and the topic corresponding to the subscription field, and displaying the retrieved document and the recommended document in a combined manner in descending order of the matching degrees with the topic corresponding to the subscription field.

When the combining display rule includes the document diversity combining display rule, for example, document diversity includes a quantity of documents of the same account, combining processing is performed on a retrieved document and a recommended document based on the quantity of documents of the same account, to obtain the retrieved document and the recommended document on which combining processing is performed, and the retrieved document and the recommended document on which combining processing is performed are displayed. Exemplarily, there are four retrieved documents, three of the retrieved documents belong to the same account, there are two recommended documents, and the two recommended documents belong to the same account. It is assumed that a quantity of documents of the same account is not more than two, and in this case, combining processing may be performed on the four retrieved documents and the two recommended documents based on a quantity of documents of the same account. The combining processing herein may include: deleting any one of the three retrieved documents belonging to the same account, to finally obtain three retrieved documents and two recommended documents, and displaying the three retrieved documents and the two recommended documents.

E. Screen the retrieved document and the recommended document in descending order of attention degrees, and displaying a document obtained through screening. In an implementation, the retrieved document and the recommended document are screened in descending order of the attention degrees, to obtain Y documents, and the Y documents are displayed. Exemplarily, Y=2, and the plurality of documents include a retrieved document 1, a retrieved document 2, and a recommended document 1. An attention degree of the retrieved document 1 is higher than an attention degree of the retrieved document 2, the attention degree of the retrieved document 2 is higher than an attention degree of the recommended document 1, and the retrieved document and the recommended document are screened in descending order of the attention degrees, to obtain two documents, that is, the retrieved document 1 and the retrieved document 2.

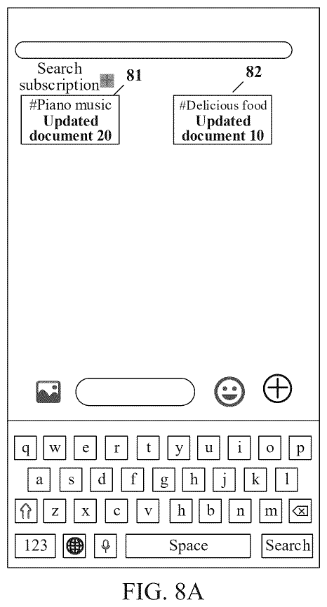

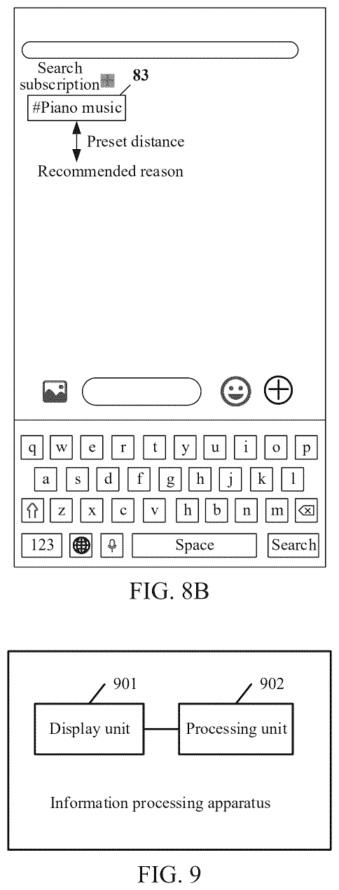

In some feasible embodiments, there may be an update to a document related to the subscription field. In this case, the followed information includes a content update notification, and the content update notification is configured for prompting that there is an update to the document related to the subscription field. In this embodiment, the outputting followed information related to the subscription field may include at least one of the following: (1) Output the content update notification at a display location of the subscription field. Exemplarily, FIG. 8A is a schematic diagram of a content update notification according to an exemplary embodiment of this application. The content update notification includes a quantity of updated documents related to a subscription field. In FIG. 8A, a quantity 20 of updated documents related to a subscription field “piano music” is displayed at a display location 81 of the subscription field “piano music”, and a quantity 10 of updated documents related to a subscription field “delicious food” is displayed at a display location 82 of the subscription field “delicious food”. (2) Output the content update notification around the display location of the subscription field. Around the display location may be understood as: any location whose distance to the display location of the subscription field is less than or equal to a preset distance (such as 1 mm or 0.1 mm). Exemplarily, FIG. 8B is a schematic diagram of a content update notification according to another exemplary embodiment of this application. The content update notification includes a recommended reason. In FIG. 8B, a recommended reason “there is a document update about the model technology” is displayed around a display location 83 of the subscription field. (3) Output the content update notification by using a third interface independent of the information retrieval interface. The third interface may be any interface in the terminal other than the information retrieval interface. For example, the third interface may be a main interface, a standby interface, a message prompt interface of the terminal, an information interface on which a client in the terminal is located, a service interface, or the like. This is not limited in this embodiment of this application.

An output form of the content update notification may include at least one of the following: \textcircled{1} Output the content update notification in a form of text. For example, both in FIG. 8A and FIG. 8B, the content update notification is outputted in a form of text. \textcircled{2} Output the content update notification in a highlighting manner. The highlighting manner herein may be, for example, a pattern with colors (for example, a dot with colors), a bold manner, an inclined manner, or a magnified manner. For example, the content update notification is outputted in a bold manner in FIG. 8A. \textcircled{3} Output the content update notification in a voice manner. When there is a content update notification, the content update notification is directly played by voice.

As described above, the content update notification is actively outputted, so that the object does not need to actively check, on the information retrieval interface, whether there is a content update of a subscribed subscription field. This simplifies an information retrieval operation, improves information retrieval efficiency, and can better improve object experience.

An information processing apparatus provided in the embodiments of this application is described below.

Referring to FIG. 9, FIG. 9 is a schematic diagram of a structure of an information processing apparatus according to an embodiment of this application. The information processing apparatus may be a computer program (including program code) in a computer device. For example, the information processing apparatus may be application software in the computer device. The information processing apparatus may be configured to perform some or all operations in the method embodiment shown in FIG. 3A. Referring to FIG. 9, the information processing apparatus includes the following units:
a display unit 901, configured to display an information retrieval interface, the information retrieval interface being configured for performing information retrieval based on a search field;
the display unit 901 being further configured to display a subscription field, the subscription field being a configured search field; and
a processing unit 902, configured to output followed information related to the subscription field.

The processing unit 902 is further configured to:
obtain the subscription field, the subscription field supporting editing, and the editing including modification or deletion; and
and display the changed subscription field when the subscription field changes due to editing.

The information retrieval interface is provided with a search subscription option. The processing unit 902 is specifically configured to:
display a search subscription input window in response to triggering of the search subscription option;
receive a first search field inputted in the search subscription input window; and
configure the first search field as the subscription field.

The information retrieval interface includes a search field input control. The processing unit 902 is specifically configured to:
receive a second search field inputted in the search field input control; and
configure the second search field as the subscription field in response to a configuration operation on the second search field.

The processing unit 902 is specifically configured to:
display at least one historical search field, the historical search field being a search field used in a historical information retrieval process; and
receive a selection operation on the historical search field, and configure the selected historical search field as the subscription field.

The information retrieval interface is provided with a search subscription option. The processing unit 902 is specifically configured to:
display one or more candidate search fields in response to triggering of the search subscription option; and
receive a selection operation on the candidate search field, and configure the selected candidate search field as the subscription field.

A quantity of the subscription fields is N. The display unit 901 is specifically configured to:
display the subscription field on the information retrieval interface;
display the subscription field on a first interface independent of the information retrieval interface;
display N subscription fields in a tiled manner;
display the N subscription fields according to a time order in which the N subscription fields are configured;
display the N subscription fields in descending order of attention degrees;
randomly display the N subscription fields;
display the N subscription fields by category based on topics to which the N subscription fields respectively belong;
display the N subscription fields in a collapsed manner; and
display the N subscription fields in descending order of field lengths of the N subscription fields.

The processing unit 902 is specifically configured to:
output the followed information in a fixed area on the information retrieval interface;
output the followed information in a floating area on the information retrieval interface; and
output the followed information on a second interface independent of the information retrieval interface.

The followed information includes a service recall result obtained by performing information retrieval based on the subscription field, the service recall result includes a plurality of documents matching the subscription field, and the documents include articles, web pages, videos, images, or audio. The processing unit 902 is specifically configured to:
display the plurality of documents in a random order;
display the plurality of documents in descending order of matching degrees with the subscription field;
display the plurality of documents in descending order of attention degrees;
display the plurality of documents in sequence according to a requirement on document diversity; and
display the plurality of documents in clusters based on topics or tags to which the documents belong.

The followed information includes a service recall result obtained by performing information retrieval based on the subscription field, the service recall result includes a plurality of documents matching the subscription field, and the plurality of documents include a browsed document and a not browsed document. The processing unit 902 is specifically configured to:
filter out the browsed document, and display only the not browsed document;
display the browsed document and the not browsed document in different areas of the same interface;
display the browsed document and the not browsed document on different interfaces;
display the not browsed document, and collapse the browsed document on a display interface of the not browsed document, the collapsed browsed document supporting being triggered to be expanded and displayed; and
display the plurality of documents, and highlight the not browsed document in the plurality of documents.

The followed information includes a service recall result obtained by performing information retrieval based on the subscription field, the service recall result includes a plurality of documents matching the subscription field, and the plurality of documents include a retrieved document and a recommended document. The processing unit 902 is specifically configured to:
hide the retrieved document, and display only the recommended document;
hide the recommended document, and display only the retrieved document;
display the retrieved document and the recommended document by category;
display the retrieved document and the recommended document in a combined manner; and
screen the retrieved document and the recommended document in descending order of attention degrees, and display a document obtained through screening.

The followed information includes a content update notification of the subscription field. The processing unit 902 is specifically configured to:
output the content update notification at a display location of the subscription field;
output the content update notification around the display location of the subscription field; and
output the content update notification by using a third interface independent of the information retrieval interface.

The content update notification includes one or two of the following: a quantity of updated documents and a recommended reason; and an output form of the content update notification includes at least one of the following: outputting the content update notification in a form of text; outputting the content update notification in a highlighting manner; and outputting the content update notification in a voice manner.

The followed information includes a service recall result obtained by performing information retrieval based on the subscription field, and the service recall result includes a search recall result. The processing unit 902 is further configured to:
retrieve, from a search document repository through a search recall pipeline, M candidate retrieved documents matching the subscription field in a first preset time period; M being a positive integer;
perform filtering processing on the M candidate retrieved documents based on a historical browsing record of an object, to obtain L candidate retrieved documents that are not browsed; L being less than or equal to M;
perform ranking processing on the L candidate retrieved documents that are not browsed, to obtain the L ranked candidate retrieved documents;
perform personalized retrieved document recall processing based on personalized data of the object, to obtain a personalized retrieved document;
perform combining and ranking processing on the L ranked candidate retrieved documents and the personalized retrieved document, to obtain the search recall result; and
obtain, based on the search recall result, the recall result obtained by performing information retrieval based on the subscription field.

The service recall result further includes a recommendation recall result. The processing unit 902 is further configured to:
determine, based on the subscription field from a recall recommendation document repository provided by a recommendation recall pipeline, a topic or a tag mapped to the subscription field; the recall recommendation document repository including at least one of the following: candidate recommended documents corresponding to different topics, and candidate recommended documents corresponding to different tags; the candidate recommended documents in the recall recommendation document repository being built by ranking candidate recommended documents in a target time period in descending order of weights of the candidate recommended documents and based on first Y candidate recommended documents in the ranked candidate recommended documents;
retrieve, in the recall recommendation document repository based on the mapped topic or tag, candidate recommended documents matching the subscription field;
perform, based on a ranking parameter, ranking processing on the matched candidate recommended documents obtained through retrieval, to obtain the ranked candidate recommended documents;
perform filtering processing on the ranked candidate recommended documents based on the historical browsing record, to obtain not browsed candidate recommended documents;
perform the ranking processing again on the not browsed candidate recommended documents based on object information and the personalized data, to obtain the recommendation recall result; and
perform combining processing on the search recall result and the recommendation recall result, to obtain the service recall result.

The followed information includes a content update notification of the subscription field. The processing unit 902 is further configured to:
obtain the subscription field from a scheduling queue, and retrieve, from a local search document repository through the search recall pipeline, one or more local retrieved documents matching the subscription field; a publication time of each local retrieved document in the local search document repository falling within a second preset time period;
determine, from the recall recommendation document repository provided by the recommendation recall pipeline, a topic or a tag mapped to the subscription field, and retrieve, in the recall recommendation document repository based on the mapped topic or tag, one or more candidate recommended documents matching the subscription field;
perform, based on the historical browsing record, filtering processing on the one or more local retrieved documents retrieved in the search recall pipeline, to obtain a first filtering result;
perform, based on the historical browsing record, filtering processing on the one or more candidate recommended documents retrieved in the recommendation recall pipeline, to obtain a second filtering result;
perform combining processing on the first filtering result and the second filtering result, to obtain an update recall result; and
generate a content update notification of the subscription field based on the update recall result if the update recall result is not an empty set.

In this embodiment of this application, the information retrieval interface is displayed, and the information retrieval interface is configured for performing information retrieval based on a search field. A subscription field is displayed, and the subscription field is a configured search field; and followed information related to the subscription field is outputted. In the foregoing manner, not only information retrieval may be performed on the information retrieval interface based on the search field, but also the object may configure the search field as the subscription field according to a continuous following requirement of the object. The configured search field that needs to be continuously followed may be presented by displaying the subscription field, to learn of a search field in which the object is continuously interested. Information retrieval may also be continuously performed by using the subscription field, to obtain and output information in which the object is continuously interested, thereby enriching information retrieval manners, improving information retrieval flexibility, and therefore, being capable of better adapting to a scenario in which the object continuously follows information.

A computer device provided in the embodiments of this application is described below.

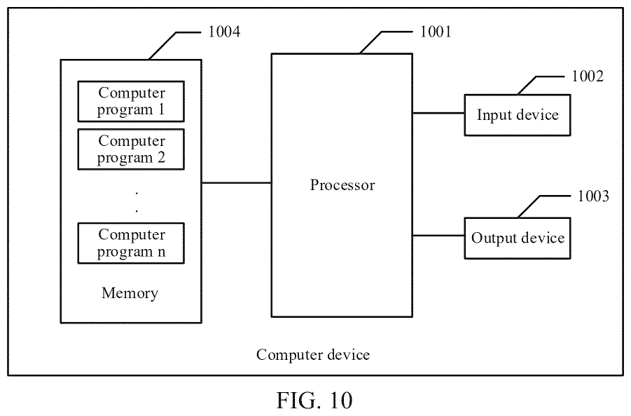

Further, an embodiment of this application further provides a schematic diagram of a structure of a computer device. The schematic diagram of the structure of the computer device is shown in FIG. 10. The computer device may be the foregoing server, and the computer device may include: a processor 1001, an input device 1002, an output device 1003, and a memory 1004. The processor 1001, the input device 1002, the output device 1003, and the memory 1004 are connected by a bus. The memory 1004 is configured to store a computer program, the computer program includes program instructions, and the processor 1001 is configured to execute the program instructions stored in the memory 1004. The processor 1001 is configured to run program instructions in the memory 1004 to execute description of the information processing method in the embodiment corresponding to FIG. 3A, or may execute description of the information processing apparatus in the embodiment corresponding to FIG. 9. Details are not described herein again. In addition, the description of beneficial effects of the same method are not described herein again.

In addition, an embodiment of this application further provides a non-transitory computer-readable storage medium, having a computer program stored therein, and the computer program includes program instructions. When the program instructions are executed by a processor, the method in the embodiment corresponding to FIG. 3A can be executed, and descriptions thereof are omitted herein. For technical details that are not disclosed in the embodiments of the computer-readable storage medium included in this application, refer to the descriptions about the method embodiments of this application. In an example, the program instructions may be deployed to be executed on a computer device, or deployed to be executed on a plurality of computer devices at the same location, or deployed to be executed on a plurality of computer devices that are distributed in a plurality of locations and interconnected by using a communication network.

One aspect of this application provides a computer program product. The computer program product includes a computer program. The computer program is stored in a computer-readable storage medium. The processor of the computer device reads the computer program from the computer-readable storage medium, and the processor executes the computer program to enable the computer device to execute the method in the embodiment corresponding to FIG. 3A, and descriptions thereof are omitted herein.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. An information processing method performed by a computer device, comprising:
displaying an information retrieval interface;
displaying a subscription field in the information retrieval interface, the subscription field being a configured search field by a user of the computer device;
obtaining the subscription field from the user of the computer device, the subscription field supporting editing, and the editing comprising modification or deletion;
refreshing and displaying the changed subscription field when the subscription field changes due to editing; and
outputting information related to the subscription field and subscribed by the user of the computer device.

2. The method according to claim 1, wherein the information retrieval interface is provided with a search subscription option; and the obtaining the subscription field comprises:
displaying a search subscription input window in response to triggering of the search subscription option;
receiving a first search field inputted in the search subscription input window; and
configuring the first search field as the subscription field.

3. The method according to claim 1, wherein the information retrieval interface comprises a search field input control; and the obtaining the subscription field comprises:
receiving a second search field inputted in the search field input control; and
configuring the second search field as the subscription field in response to a configuration operation on the second search field.

4. The method according to claim 1, wherein the obtaining the subscription field comprises:
displaying at least one historical search field, the historical search field being a search field used in a historical information retrieval process; and
receiving a selection operation on the historical search field, and configuring the selected historical search field as the subscription field.

5. The method according to claim 1, wherein the information retrieval interface is provided with a search subscription option; and the obtaining the subscription field comprises:
displaying one or more candidate search fields in response to triggering of the search subscription option; and
receiving a selection operation on the candidate search field, and configuring the selected candidate search field as the subscription field.

6. The method according to claim 1, wherein a quantity of the subscription fields is N; and the displaying a subscription field in the information retrieval interface comprises at least one of the following:
displaying the subscription field on the information retrieval interface;
displaying the subscription field on a first interface independent of the information retrieval interface;
displaying N subscription fields in a tiled manner;
displaying the N subscription fields according to a time order in which the N subscription fields are configured;
displaying the N subscription fields in descending order of attention degrees;
randomly displaying the N subscription fields;
displaying the N subscription fields by category based on topics to which the N subscription fields respectively belong;
displaying the N subscription fields in a collapsed manner; and
displaying the N subscription fields in descending order of field lengths of the N subscription fields.

7. The method according to claim 1, wherein the outputting information related to the subscription field and subscribed by the user of the computer device comprises at least one of the following:
outputting the information in a fixed area in the information retrieval interface;
outputting the information in a floating area in the information retrieval interface; and
outputting the information in a second interface independent of the information retrieval interface.

8. The method according to claim 1, wherein the information comprises a service recall result obtained by performing information retrieval based on the subscription field, the service recall result comprises a plurality of documents matching the subscription field, and the documents comprise articles, web pages, videos, images, or audio; and the outputting information related to the subscription field and subscribed by the user of the computer device comprises at least one of the following:
displaying the plurality of documents in a random order;
displaying the plurality of documents in descending order of matching degrees with the subscription field;
displaying the plurality of documents in descending order of attention degrees;
displaying the plurality of documents in sequence according to a requirement on document diversity; and
displaying the plurality of documents in clusters based on topics or tags to which the documents belong.

9. The method according to claim 1, wherein the information comprises a service recall result obtained by performing information retrieval based on the subscription field, the service recall result comprises a plurality of documents matching the subscription field, and the plurality of documents comprise a browsed document and a not browsed document; and the outputting information related to the subscription field and subscribed by the user of the computer device comprises at least one of the following:
filtering out the browsed document, and displaying only the not browsed document;
displaying the browsed document and the not browsed document in different areas of the same interface;
displaying the browsed document and the not browsed document on different interfaces;
displaying the not browsed document, and collapsing the browsed document in a display interface of the not browsed document, the collapsed browsed document supporting being triggered to be expanded and displayed; and
displaying the plurality of documents, and highlighting the not browsed document in the plurality of documents.

10. The method according to claim 1, wherein the information comprises a service recall result obtained by performing information retrieval based on the subscription field, the service recall result comprises a plurality of documents matching the subscription field, and the plurality of documents comprise a retrieved document and a recommended document; and the outputting information related to the subscription field and subscribed by the user of the computer device comprises at least one of the following:
hiding the retrieved document, and displaying only the recommended document;
hiding the recommended document, and displaying only the retrieved document;
displaying the retrieved document and the recommended document by category;
displaying the retrieved document and the recommended document in a combined manner; and
screening the retrieved document and the recommended document in descending order of attention degrees, and displaying a document obtained through screening.

11. The method according to claim 1, wherein the information comprises a content update notification of the subscription field; and the outputting information related to the subscription field and subscribed by the user of the computer device comprises at least one of the following:
outputting the content update notification at a display location of the subscription field;
outputting the content update notification around the display location of the subscription field; and
outputting the content update notification by using a third interface independent of the information retrieval interface;
the content update notification comprising one or two of the following: a quantity of updated documents and a recommended reason; and an output form of the content update notification comprising at least one of the following: outputting the content update notification in a form of text; outputting the content update notification in a highlighting manner; and outputting the content update notification in a voice manner.

12. The method according to claim 1, wherein the information comprises a service recall result obtained by performing information retrieval based on the subscription field, and the service recall result comprises a search recall result; and the method further comprises:
retrieving, from a search document repository through a search recall pipeline, M candidate retrieved documents matching the subscription field in a first preset time period; M being a positive integer;
performing filtering processing on the M candidate retrieved documents based on a historical browsing record of an object, to obtain L candidate retrieved documents that are not browsed; L being less than or equal to M;
performing ranking processing on the L candidate retrieved documents that are not browsed, to obtain the L ranked candidate retrieved documents;
performing personalized retrieved document recall processing based on personalized data of the object, to obtain a personalized retrieved document; and
performing combining and ranking processing on the L ranked candidate retrieved documents and the personalized retrieved document, to obtain the search recall result.

13. The method according to claim 1, wherein the service recall result further comprises a recommendation recall result; and the method further comprises:
determining, based on the subscription field from a recall recommendation document repository provided by a recommendation recall pipeline, a topic or a tag mapped to the subscription field; the recall recommendation document repository comprising at least one of the following: candidate recommended documents corresponding to different topics, and candidate recommended documents corresponding to different tags; the candidate recommended documents in the recall recommendation document repository being built by ranking candidate recommended documents in a target time period in descending order of weights of the candidate recommended documents and based on first Y candidate recommended documents in the ranked candidate recommended documents;
retrieving, in the recall recommendation document repository based on the mapped topic or tag, candidate recommended documents matching the subscription field;
performing, based on a ranking parameter, ranking processing on the matched candidate recommended documents obtained through retrieval, to obtain the ranked candidate recommended documents;
performing filtering processing on the ranked candidate recommended documents based on the historical browsing record, to obtain not browsed candidate recommended documents;
performing the ranking processing again on the not browsed candidate recommended documents based on object information and the personalized data, to obtain the recommendation recall result; and
performing combining processing on the search recall result and the recommendation recall result, to obtain the service recall result.

14. The method according to claim 1, wherein the information comprises a content update notification of the subscription field; and the method further comprises:
obtaining the subscription field from a scheduling queue, and retrieving, from a local search document repository through the search recall pipeline, one or more local retrieved documents matching the subscription field; a document publication time of each local retrieved document in the local search document repository falling within a second preset time period;
determining, from the recall recommendation document repository provided by the recommendation recall pipeline, a topic or a tag mapped to the subscription field, and retrieving, in the recall recommendation document repository based on the mapped topic or tag, one or more candidate recommended documents matching the subscription field;
performing, based on the historical browsing record of the object, filtering processing on the one or more local retrieved documents retrieved in the search recall pipeline, to obtain a first filtering result;
performing, based on the historical browsing record, filtering processing on the one or more candidate recommended documents retrieved on the recommendation recall pipeline, to obtain a second filtering result;
performing combining processing on the first filtering result and the second filtering result, to obtain an update recall result; and
generating a content update notification of the subscription field based on the update recall result if the update recall result is not an empty set.

15. A computer device, comprising:
a processor, configured to execute a computer program; and
a computer-readable storage medium, the computer-readable storage medium having a computer program stored therein, the computer program, when executed by the processor, causing the computer device to perform an information processing method including:
displaying an information retrieval interface;
displaying a subscription field in the information retrieval interface, the subscription field being a configured search field by a user of the computer device;
obtaining the subscription field from the user of the computer device, the subscription field supporting editing, and the editing comprising modification or deletion;
refreshing and displaying the changed subscription field when the subscription field changes due to editing; and
outputting information related to the subscription field and subscribed by the user of the computer device.

16. The computer device according to claim 15, wherein the information retrieval interface is provided with a search subscription option; and the obtaining the subscription field comprises:
displaying a search subscription input window in response to triggering of the search subscription option;
receiving a first search field inputted in the search subscription input window; and
configuring the first search field as the subscription field.

17. The computer device according to claim 15, wherein the information retrieval interface comprises a search field input control; and the obtaining the subscription field comprises:
receiving a second search field inputted in the search field input control; and
configuring the second search field as the subscription field in response to a configuration operation on the second search field.

18. The computer device according to claim 15, wherein the obtaining the subscription field comprises:
displaying at least one historical search field, the historical search field being a search field used in a historical information retrieval process; and
receiving a selection operation on the historical search field, and configuring the selected historical search field as the subscription field.

19. The computer device according to claim 15, wherein the information retrieval interface is provided with a search subscription option; and the obtaining the subscription field comprises:
displaying one or more candidate search fields in response to triggering of the search subscription option; and
receiving a selection operation on the candidate search field, and configuring the selected candidate search field as the subscription field.

20. A non-transitory computer-readable storage medium having a computer program stored therein, the computer program, when executed by a processor of a computer device, causing the computer device to perform an information processing method including:
displaying an information retrieval interface;
displaying a subscription field in the information retrieval interface, the subscription field being a configured search field by a user of the computer device;
obtaining the subscription field from the user of the computer device, the subscription field supporting editing, and the editing comprising modification or deletion;
refreshing and displaying the changed subscription field when the subscription field changes due to editing; and
outputting information related to the subscription field and subscribed by the user of the computer device.
